(19) United States
(12) Patent Application Publication
(10) Pub. No.: US 2024/0357498 A1
(43) Pub. Date: Oct. 24, 2024

(54) WI-FI AWARE POWER SAVE

(71) Applicant: QUALCOMM INCORPORATED, San Diego, CA (US)

(72) Inventors: Shivraj Singh SANDHU, Milpitas, CA (US); Sudhanshu SINGH, Hyderabad (IN); Alireza RAISSINIA, Monte Sereno, CA (US); Sandip HOMCHAUDHURI, San Jose, CA (US); Sheshu Kumar TULA, San Jose, CA (US); Ye YUAN, Fremont, CA (US)

(21) Appl. No.: 18/685,851

(22) PCT Filed: Sep. 28, 2022
(86) PCT No.: PCT/US2022/045110

§ 371 Date: Feb. 22, 2024

(30) Foreign Application Priority Data
Oct. 6, 2021 (IN) 202121045524

(51) Int. Cl. H04W 52/02; H04W 28/02; H04W 84/18

(52) U.S. Cl. CPC H04W 52/0235; H04W 28/0289; H04W 84/18

(57) ABSTRACT

This disclosure describes a power save mechanism for devices in a neighbor awareness networking (NAN) network. In some aspects, a NAN device is able to enter into a power save mode during a window agreed to between the NAN device and a NAN peer device. A NAN device transmits, to a NAN peer device, an indication that the wireless communication device is to enter a power save mode. For example, the NAN device may transmit a MAC packet with a more data (MD) bit set to 0. The NAN peer device may indicate that the NAN device is allowed to enter the power save mode by transmitting a MAC packet with the MD bit set to 0, or the NAN peer device may indicate that the wireless communication device is not to enter the power save mode by transmitting a MAC packet with the MD bit set to 1.

### CROSS REFERENCE TO RELATED APPLICATIONS

The present Application is a 371 national stage filing of International PCT Application No. PCT/US2022/045110 by SANDHU et al. entitled “WI-FI AWARE POWER SAVE,” filed Sep. 28, 2022; and claims priority to Indian Patent Application No. 202121045524 by SANDHU et al. entitled “WI-FI AWARE POWER SAVE,” filed Oct. 6, 2021, each of which is assigned to the assignee hereof, and each of which is expressly incorporated by reference in its entirety herein.

### TECHNICAL FIELD

This disclosure relates generally to wireless communication, and more specifically, to a power save mechanism for devices in Wi-Fi Aware networks.

### DESCRIPTION OF THE RELATED TECHNOLOGY

An infrastructure wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Another type of WLAN is a peer-to-peer (P2P), ad hoc, or mesh network. In such a WLAN, STAs can communicate directly with each other via P2P wireless links (without the use of an intermediary AP). An example P2P network is a neighbor awareness networking (NAN) network (also referred to as a Wi-Fi Aware network). NAN networks operate in accordance with the Wi-Fi Alliance (WFA) Wi-Fi Aware standard specification (also referred to as the NAN standard specification). NAN-compliant STAs (also referred to as “NAN devices”) transmit and receive NAN communications to and from one another via wireless P2P links.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device for neighbor awareness networking. The wireless communication device includes an interface configured to transmit, to a NAN peer device over a NAN data path (NDP), an indication that the wireless communication device is to enter a power save mode. The wireless communication device also includes a processing system configured to cause the wireless communication device to enter into the power save mode for a first amount of time. In some implementations, the indication may include a media access control (MAC) packet with a more data (MD) bit set to 0. In some implementations, the processing system may be configured to cause the wireless communication device to remain in an active mode during a dwell time after transmitting the indication.

Another innovative aspect of the subject matter described in this disclosure can be implemented in a method by an apparatus of a wireless communication device for wireless communication. The method includes transmitting, to a NAN peer device over an NDP, an indication that the wireless communication device is to enter a power save mode. The method also includes entering the power save mode for a first amount of time. In some implementations, the indication may include a media access control (MAC) packet with a more data (MD) bit set to 0. In some implementations, the method also may include remaining in an active mode during a dwell time after transmitting the indication.

Another innovative aspect of the subject matter described in this disclosure can be implemented in a wireless communication device. The wireless communication device includes a processing system and an interface configured to receive, from a NAN peer device over an NDP, an indication that the NAN peer device is to enter a power save mode (with the NAN peer device entering the power save mode for a first amount of time). In some implementations, the indication may include a media access control (MAC) packet with a more data (MD) bit set to 0. In some implementations, the interface may be configured to transmit, to the NAN peer device over the NDP, an indication that the NAN peer device is not to enter the power save mode (with the NAN peer device not entering the power save mode). In some implementations, the interface is configured to transmit, to the NAN peer device over the NDP, an indication that the NAN peer device is to enter the power save mode (with the NAN peer device entering the power save mode in response to receiving the indication that the NAN peer device is to enter the power save mode).

Another innovative aspect of the subject matter described in this disclosure can be implemented in a method by an apparatus of a wireless communication device for wireless communication. The method includes receiving, from a NAN peer device over an NDP, an indication that the NAN peer device is to enter a power save mode (with the NAN peer device entering the power save mode for a first amount of time). In some implementations, the indication may include a media access control (MAC) packet with a more data (MD) bit set to 0. In some implementations, the method also may include transmitting, to the NAN peer device over the NDP, an indication that the NAN peer device is not to enter the power save mode (with the NAN peer device not entering the power save mode). In some implementations, the method also may include transmitting, to the NAN peer device over the NDP, an indication that the NAN peer device is to enter the power save mode (with the NAN peer device entering the power save mode in response to receiving the indication that the NAN peer device is to enter the power save mode).

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless local area network (WLAN).

FIG. 2A shows an example protocol data unit (PDU) usable for communications between an access point (AP) and one or more stations (STAs) or between STAs.

FIG. 2B shows an example field in the PDU of FIG. 2A.

FIG. 3 shows a pictorial diagram of another example wireless communication network.

FIG. 4 shows a block diagram of an example wireless communication device.

FIG. 5 shows a block diagram of an example station (STA).

FIG. 6 shows a flowchart illustrating an example process for power save in a neighbor awareness networking (NAN) network.

FIG. 7 shows an example timing diagram of a wireless communication device entering into a power save mode after a unilateral trigger condition occurring over a NAN data path (NDP).

FIG. 8 shows an example timing diagram of a wireless communication device entering into a power save mode after a mutually agreed trigger condition occurring over an NDP.

FIG. 9 shows an example timing diagram of a wireless communication device waiting a dwell time after transmitting an indication to enter a power save mode.

FIG. 10 shows an example timing diagram of a wireless communication device ending a dwell time in response to receiving an indication that the wireless communication device is to enter a power save mode.

FIG. 11 shows an example timing diagram of a wireless communication device preventing entering a power save mode in response to receiving an indication to prevent entering the power save mode.

FIG. 12 shows an example timing diagram of a wireless communication device entering a power save mode after previously being prevented from entering the power save mode.

FIG. 13 shows a flowchart illustrating an example process for adjusting a dwell time.

FIG. 14 shows a flowchart illustrating an example process for power save in a NAN network.

FIG. 15 shows a flowchart illustrating an example process for preventing a NAN peer device from entering a power save mode.

FIG. 16 shows a flowchart illustrating an example process for indicating a NAN peer device is to enter a power save mode.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

A type of wireless network is a neighbor awareness networking (NAN) network (also referred to as a Wi-Fi Aware network), which may be defined by the Wi-Fi Aware™ Specification released by the Wi-Fi Alliance (WFA). In a NAN network, NAN devices are configured to communicate with each other without the use of an intermediary access point (AP). NAN devices may be coupled to each other via a NAN device link (NDL), and each NDL may include one or more NAN data paths (NDPs). For an NDP between NAN devices, the NAN devices may be expected to be awake (also referred to as being in an active mode) during one or more common resource blocks (CRBs) of time slots agreed to between the NAN devices. One problem with NAN devices being awake during the agreed to CRBs is that the NAN devices consume processing resources and power even when no data is to be transmitted between the devices. As such, there is a need for NAN devices to be able to enter into a power save mode in some instances.

Various aspects relate generally to a NAN device being able to enter into a power save mode during a window agreed to between the NAN device and a NAN peer device (also referred to as a peer NAN device). In some implementations, a wireless communication device transmits, to a NAN peer device over an NDP, an indication that the wireless communication device is to enter a power save mode. For example, the wireless communication device may transmit a media access control (MAC) packet with a power management (PM) bit set to 1 to indicate that the wireless communication device unilaterally is entering a power save mode. The wireless communication device may enter the power save mode in accordance with transmitting the indication that the wireless communication device is to enter the power save mode. In another example, the wireless communication device may transmit a MAC packet with a more data (MD) bit set to 0 to indicate to the NAN peer device that the wireless communication device desires to enter a power save mode. The NAN peer device may indicate that the wireless communication device is allowed to enter into the power save mode (such as by transmitting a MAC packet with the MD bit set to 0), or the NAN peer device may indicate that the wireless communication device is not to enter into the power save mode (such as by transmitting a MAC packet with the MD bit set to 1).

Particular aspects of the subject matter described in this disclosure can be implemented to realize one or more of the following potential advantages. The described techniques regarding power save in a Wi-Fi Aware network can be used to conserve power at a NAN device. The described techniques also can be used to conserve processing resources at the NAN device.

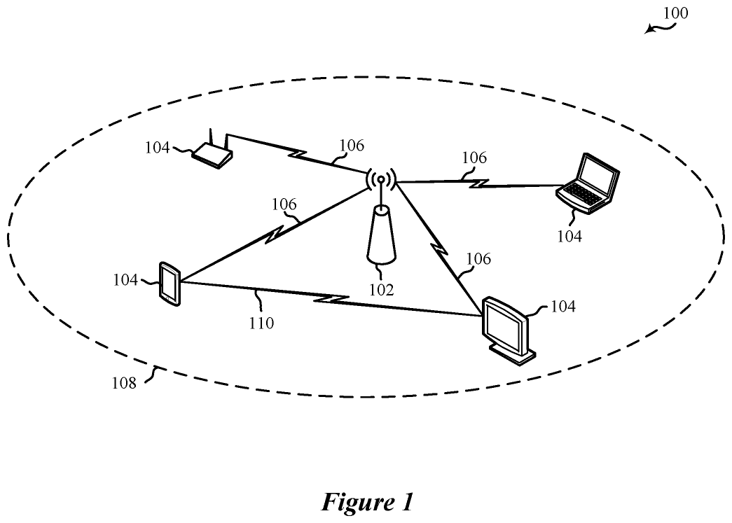

FIG. 1 shows a block diagram of an example wireless local area network (WLAN) 100. According to some aspects, the WLAN 100 can be an example of a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (such as TVs, computer monitors, navigation systems, among others), music or other audio or stereo devices, remote control devices (“remotes”), printers, kitchen or other household appliances, key fobs (such as for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (such as the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on (such as in accordance with) the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan the surroundings of the STA 104 to find a more suitable AP 102 with which to associate. For example, a STA 104 that is moving relative to an AP 102 associated with the STA 104 may perform a “roaming” scan to find another AP 102 having more desirable network characteristics such as a greater received signal strength indicator (RSSI) or a reduced traffic load.

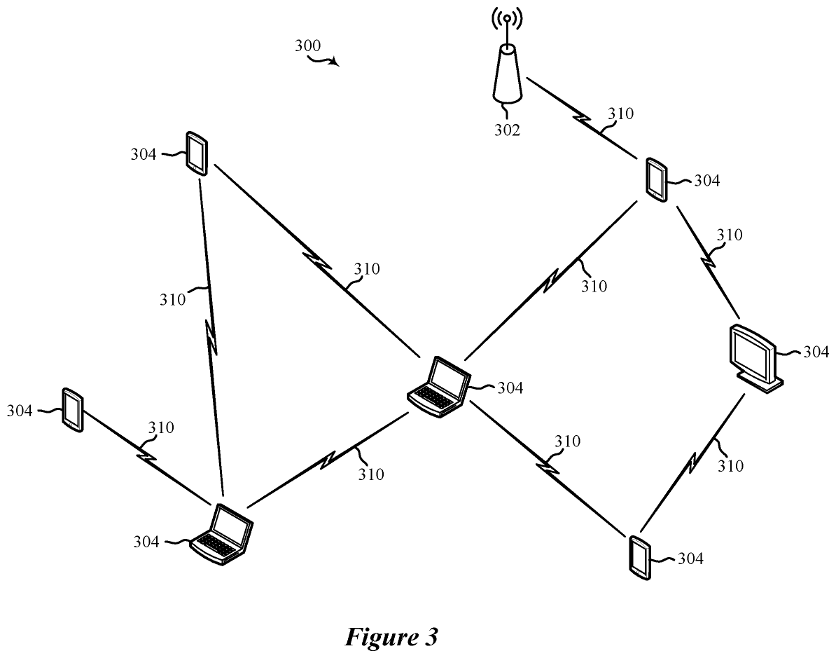

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100 or may operate concurrently with a wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections. In another example of an ad-hoc wireless network, the wireless network may be a neighbor awareness networking (NAN) network (also referred to as a Wi-Fi Aware network), which may be defined by the Wi-Fi Aware Specification released by the Wi-Fi Alliance (WFA). As used herein, NAN and Wi-Fi Aware may be used interchangeably. A NAN network is described in more detail herein with reference to FIG. 3.

Referring back to FIG. 1, the APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or CCC20 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble may be based on or associated with the particular IEEE 802.11 protocol to be used to transmit the payload.

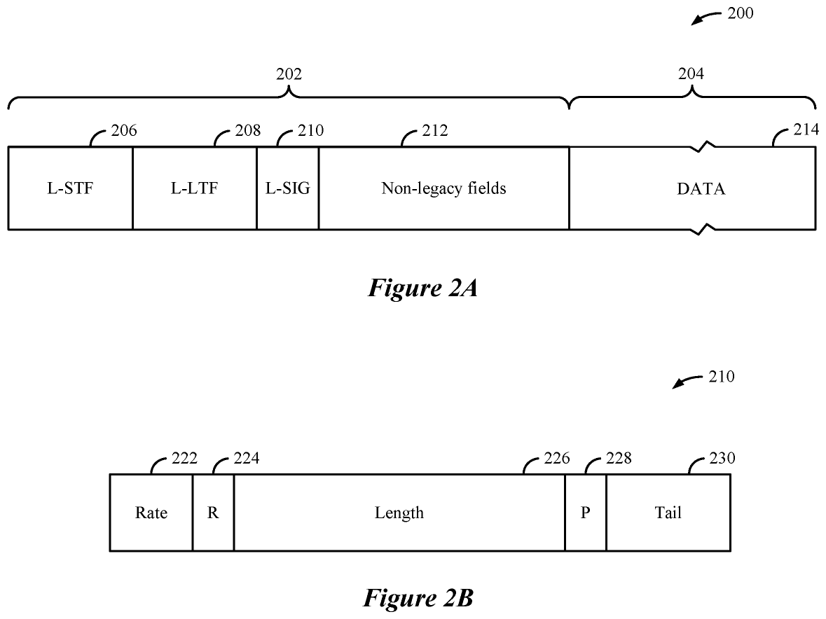

FIG. 2A shows an example protocol data unit (PDU) 200 usable for wireless communication between an AP 102 and one or more STAs 104 or between STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two BPSK symbols, a legacy long training field (L-LTF) 208, which may consist of two BPSK symbols, and a legacy signal field (L-SIG) 210, which may consist of two BPSK symbols. The legacy portion of the preamble 202 may be configured according to the IEEE 802.11a wireless communication protocol standard. The preamble 202 also may include anon-legacy portion including one or more non-legacy fields 212, for example, conforming to an IEEE wireless communication protocol such as the IEEE 802.11ac, 802.11ax, 802.11be or later wireless communication protocol protocols.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to select, identify, ascertain, or otherwise determine a duration of the PDU and to use the duration to avoid transmitting on top of the PDU. For example, the L-STF 206, the L-LTF 208 and the L-SIG 210 may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of medium access control (MAC) protocol data units (MPDUs) or an aggregated MPDU (A-MPDU). An MPDU or an A-MPDU may be referred to herein as a MAC packet (which may include a control packet or a data packet).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 222 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (such as a Viterbi decoder). The receiving device may utilize the data rate and the length indicated in the data rate field 222 and the length field 226 to select, identify, ascertain, or otherwise determine a duration of the packet in units of, for example, microseconds (μs) or other time units.

Access to a shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, the wireless communication device may expect to wait for a particular time and contend for access to the wireless medium at the particular time. In some implementations, the wireless communication device may be configured to implement the DCF through the use of carrier sense multiple access (CSMA) with collision avoidance (CA) (CSMA/CA) techniques and timing intervals. Before transmitting data, the wireless communication device may perform a clear channel assessment (CCA) and select, identify, ascertain, or otherwise determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which may be compared to a threshold to select, identify, ascertain, or otherwise determine whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy. Virtual carrier sensing is accomplished via the use of a network allocation vector (NAV), an indicator of a time when the medium may next become idle. The NAV is reset each time a valid frame is received that is not addressed to the wireless communication device. The NAV effectively serves as a time duration that may be expected to elapse before the wireless communication device may contend for access, even in the absence of a detected symbol or even if the detected energy is below the relevant threshold.

FIG. 3 shows a pictorial diagram of another example wireless communication network 300. According to some aspects, the wireless communication network 300 can be an example of a WLAN. For example, the wireless communication network 300 can be a network implementing at least one of the IEEE 802.11 family of standards. The wireless communication network 300 may include multiple STAs 304. As described herein, each of the STAs 304 also may be referred to as a mobile station (MS), a mobile device, a mobile handset, a wireless handset, an access terminal (AT), a user equipment (UE), a subscriber station (SS), or a subscriber unit, among other examples. The STAs 304 may represent various devices such as mobile phones, personal digital assistant (PDAs), other handheld devices, netbooks, notebook computers, tablet computers, laptops, display devices (such as TVs, computer monitors, navigation systems, among others), music or other audio or stereo devices, remote control devices (“remotes”), printers, kitchen or other household appliances, key fobs (such as for passive keyless entry and start (PKES) systems), among other examples.

The wireless communication network 300 is an example of a peer-to-peer (P2P), ad hoc or mesh network. STAs 304 can communicate directly with each other via P2P wireless links 310 (without the use of an intermediary AP). In some implementations, the wireless communication network 300 is an example of a NAN network. NAN networks operate in accordance with the Wi-Fi Alliance (WFA) Wi-Fi Aware Specification (also referred to as the NAN standard specification). NAN-compliant STAs 304 (hereinafter also simply “NAN devices 304”) transmit and receive NAN communications (such as in the form of Wi-Fi packets including frames conforming to an IEEE 802.11 wireless communication protocol standard such as that defined by the IEEE 802.11-2016 specification or amendments thereof including, but not limited to, 802.11ay, 802.1 lax, 802.11az, 802.11ba and 802.11be) to and from one another via wireless P2P links 310 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 304 in the network automatically establish an ad-hoc network with other NAN devices 304 such that network connectivity can be maintained. Each NAN device 304 is configured to relay data for the NAN network such that various NAN devices 304 may cooperate in the distribution of data within the network. As a result, a message can be transmitted from a source NAN device to a destination NAN device by being propagated along a path, hopping from one NAN device to the next until the destination is reached.

Each NAN device 304 is configured to transmit two types of beacons: NAN discovery beacons and NAN synchronization beacons. When a NAN device 304 is turned on, or otherwise when NAN-functionality is enabled, the NAN device periodically transmits NAN discovery beacons (such as every 100 TUs, every 128 time units (TUs, which equals 1,024 microseconds) or another suitable period) and NAN synchronization beacons (such as every 512 TUs or another suitable period). Discovery beacons are management frames, transmitted between discovery windows, used to facilitate the discovery of NAN clusters (as defined in the NAN standard specification). NAN clusters also may be referred to herein as NAN Data Clusters (NDCs). A NAN cluster is a collection of NAN devices within a NAN network that are synchronized to the same clock and discovery window schedule using a time synchronization function (TSF). To join NAN clusters, NAN devices 304 passively scan for discovery beacons from other NAN devices. When two NAN devices 304 come within a transmission range of one another, they may discover each other based on (such as in accordance with using) such discovery beacons. Respective master preference values indicate or determine which of the NAN devices 304 will become the master device. If a NAN cluster is not discovered, a NAN device 304 may start a new NAN cluster. When a NAN device 304 starts a NAN cluster, the NAN device 304 may assume the master role and broadcasts a discovery beacon. Additionally, a NAN device may choose to participate in more than one NAN cluster within a NAN network.

The NDLs between the NAN devices 304 in a NAN cluster are associated with discovery windows, which are the times and channel on which the NAN devices converge. At the beginning of each discovery window, one or more NAN devices 304 may transmit a NAN synchronization beacon, which is a management frame used to synchronize the timing of the NAN devices within the NAN cluster to that of the master device. The NAN devices 304 may transmit multicast or unicast NAN service discovery frames (SDFs) directly to other NAN devices within the service discovery threshold and in the same NAN cluster during the discovery window in accordance with transmitting the NAN synchronization beacon. The service discovery frames indicate services supported by the respective NAN devices 304.

In some instances, NAN devices 304 may exchange service discovery frames to ascertain whether both devices support ranging operations. NAN devices 304 may perform such ranging operations (“ranging”) during the discovery windows. The ranging may involve an exchange of fine timing measurement (FTM) frames (such as those defined in IEEE 802.11-REVmc). For example, a first NAN device 304 may transmit unicast FTM requests to multiple peer NAN devices 304. The peer NAN devices 304 may transmit responses to the first NAN device 304. The first NAN device 304 may exchange FTM frames with each of the peer NAN devices 304 in accordance with receiving the responses from the peer NAN devices 304. The first NAN device 304 may select, identify, ascertain, or otherwise determine a range between itself and each of the NAN devices 304 using the FTM frames and transmit a range indication to each of the peer NAN devices 304. For example, the range indication may include a distance value or an indication as to whether a peer NAN device 304 is within a service discovery threshold (such as 3 meters(m)) of the first NAN device 304. NAN links between NAN devices within the same NAN cluster may persist over multiple discovery windows as long as the NAN devices remain within the service discovery thresholds of one another and synchronized to the anchor master of the NAN cluster.

Some NAN devices 304 also may be configured for wireless communication with other networks such as with a Wi-Fi WLAN or a wireless (such as cellular) wide area network (WWAN), which may, in turn, provide access to external networks including the Internet. For example, a NAN device 304 may be configured to associate and communicate, via a Wi-Fi or cellular link, with an AP or base station 302 of a WLAN or WWAN network, respectively. In such instances, the NAN device 304 may include software-enabled access point (SoftAP) functionality enabling the STA to operate as a Wi-Fi hotspot to provide other NAN devices 304 with access to the external networks via the associated WLAN or WWAN backhaul. Such a NAN device 304 (referred to as a NAN concurrent device) is capable of operating in both a NAN network as well as another type of wireless network, such as a Wi-Fi BSS. In some such implementations, a NAN device 304 may, in a service discovery frame, advertise an ability to provide such access point services to other NAN devices 304.

There are two general NAN service discovery messages: publish messages and subscribe messages. Generally, publishing is a mechanism for an application on a NAN device to advertise selected information about the capabilities and services of the NAN device to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make services of the publishing NAN device discoverable for other NAN devices operating within the same NAN cluster. In a passive subscriber mode, the subscribe function does not initiate the transfer of any subscribe message, rather, the subscribe function looks for matches in received publish messages to select, identify, ascertain, or otherwise determine the availability of desired services.

Discovery windows occur periodically (such as every 512 TUs). In some implementations, a discovery window is 16 TUs (which may be referred to as one time slot), and the beginnings of successive discovery windows as separated by 512 TUs (32 time slots). During a discovery window, NAN devices may negotiate or propose to negotiate during their common availability slots over a defined channel between the discovery windows. For example, each NAN device of a NAN device pair or cluster may advertise one or more further availability windows (FAWs) of consecutive time slots (such as neighboring 16 TU blocks) outside of the discovery window and a wireless channel on which the NAN device is available (such as by advertising an availability schedule). At least a portion of the FAWs may overlap between the NAN devices such that the NAN devices may be available during the same time slots and on the same channel. The NAN devices thus may negotiate at least a portion of the overlapping FAWs as a common resource block (CRB) including one or more consecutive time slots and a negotiated channel. A transmission opportunity period between the NAN devices may include one or more CRBs. As such, one or more CRBs may be referred to as or include one or more blocks of time, where a transmission opportunity period between NAN devices (such as peer devices) may include the one or more blocks of time. In other words, CRBs may be blocks of transmission time between peers. Further, blocks of transmission time may be contiguous or non-contiguous transmission blocks.

Subsequent to a discovery window is the transmission opportunity period. This period includes numerous resource blocks. A NAN device link (NDL) may refer to the negotiated resource blocks (CRBs) between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to select, identify, ascertain, or otherwise determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to an NDL peer of the NAN device during a paging window if the NAN device has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom the NDL transmitter device received a trigger frame. A NAN device that establishes an S-NDL with a peer NAN device may transmit data frames to the peer from the beginning of each S-NDL CRB without transmitting a paging message in advance.

An NDL may include one or more NAN data paths (NDPs). An NDP is associated with an upper level or application level service requiring the transmission of data between NAN devices. For example, a virtual reality (VR) service may require the transmission of video and audio frames between NAN devices. In some implementations, multiple services may require the transmission of data between the NAN devices, and each service is associated with a NAN data path (NDP). As such, the NDL between the NAN devices may include multiple NDPs. As used herein, the NDP may refer to the one or more CRBs during which the NAN devices are to be in an active mode for exchanging NAN frames associated with a service between each other. As described herein, the CRB may be associated with or an example of a negotiated schedule of contiguous time slots during which both NAN devices are available.

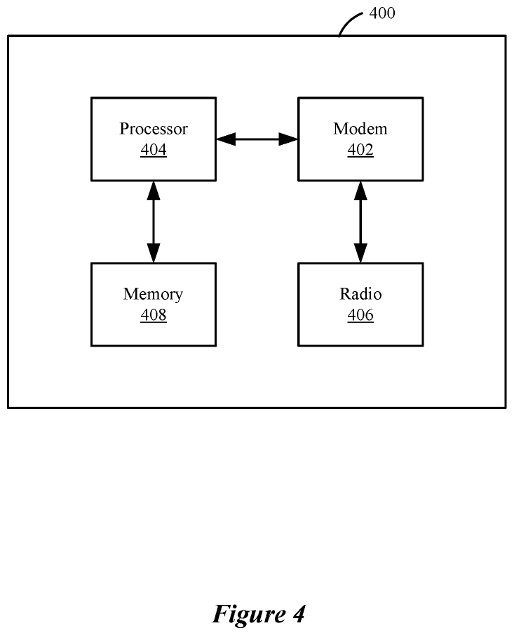

FIG. 4 shows a block diagram of an example wireless communication device 400. In some implementations, the wireless communication device 400 can be an example of a device for use in a STA such as one of the STAs 304 described herein with reference to FIG. 3. The wireless communication device 400 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 400 can be, or can include, a chip, system on chip (SoC), chipset, package or device that includes one or more modems 402, for example, a Wi-Fi (IEEE 802.11 compliant) modem. In some implementations, the one or more modems 402 (collectively “the modem 402”) additionally include a WWAN modem (such as a 3GPP 4G LTE or 5G compliant modem). In some implementations, the wireless communication device 400 also includes one or more processors, processing blocks or processing elements 404 (collectively “the processor 404”) coupled with the modem 402. In some implementations, the wireless communication device 400 additionally includes one or more radios 406 (collectively “the radio 406”) coupled with the modem 402. In some implementations, the wireless communication device 400 further includes one or more memory blocks or elements 408 (collectively “the memory 408”) coupled with the processor 404 or the modem 402.

The modem 402 can include an intelligent hardware block or device such as, for example, an application-specific integrated circuit (ASIC), among other examples. The modem 402 is generally configured to implement a PHY layer, and in some implementations, also a portion of a MAC layer (such as a hardware portion of the MAC layer). For example, the modem 402 is configured to modulate packets and to output the modulated packets to the radio 406 for transmission over the wireless medium. The modem 402 is similarly configured to obtain modulated packets received by the radio 406 and to demodulate the packets to provide demodulated packets. In addition to a modulator and a demodulator, the modem 402 may further include digital signal processing (DSP) circuitry, automatic gain control (AGC) circuitry, a coder, a decoder, a multiplexer and a demultiplexer. For example, while in a transmission mode, data obtained from the processor 404 may be provided to an encoder, which encodes the data to provide coded bits. The coded bits may be mapped to a number Nss of spatial streams for spatial multiplexing or a number NsTS of space-time streams for space-time block coding (STBC). The coded bits in the streams may be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (such as for Tx windowing and filtering). The digital signals may be provided to a digital-to-analog converter (DAC). The resultant analog signals may be provided to a frequency upconverter, and ultimately, the radio 406. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 406, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may be fed to the AGC, which is configured to use information extracted from the digital signals, for example, in one or more received training fields, to select, identify, ascertain, or otherwise determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may be descrambled and provided to the MAC layer (the processor 404) for processing, evaluation or interpretation.

The radio 406 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 400 can include, or be coupled with, multiple transmit antennas (each with a corresponding transmit chain) and multiple receive antennas (each with a corresponding receive chain). The symbols output from the modem 402 are provided to the radio 406, which transmits the symbols via the coupled antennas. Similarly, symbols received via the antennas are obtained by the radio 406, which provides the symbols to the modem 402.

The processor 404 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 404 processes information received through the radio 406 and the modem 402, and processes information to be output through the modem 402 and the radio 406 for transmission through the wireless medium. For example, the processor 404 may implement a control plane and at least a portion of a MAC layer configured to perform various operations related to the generation, transmission, reception and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 404 may generally control the modem 402 to cause the modem to perform various operations described herein.

The memory 408 can include tangible storage media such as random-access memory (RAM) or read-only memory (ROM), or combinations thereof. The memory 408 also can store non-transitory processor- or computer-executable software (SW) code containing instructions that, when executed by the processor 404, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

As used herein, a processing system of a wireless communication device may refer to one or more of the modem 402, the processor 404, or the memory 408 of the wireless communication device 400. For example, a processing system may include one or more of the processor 404, at least a portion of the modem 402, or the memory 408. As used herein, an interface of a wireless communication device may refer to one or more of the modem 402 or the radio 406 of the wireless communication device 400. For example, an interface may include one or more of at least a portion of the modem 402 or the radio 406. In some implementations, the interface may include one or more antennas coupled to or included in the wireless communication device. While some examples of a processing system and an interface of a wireless communication device are provided, any suitable components of a wireless communication device may be included in a processing system and an interface of the wireless communication device. As such, the present disclosure is not limited to the provided examples.

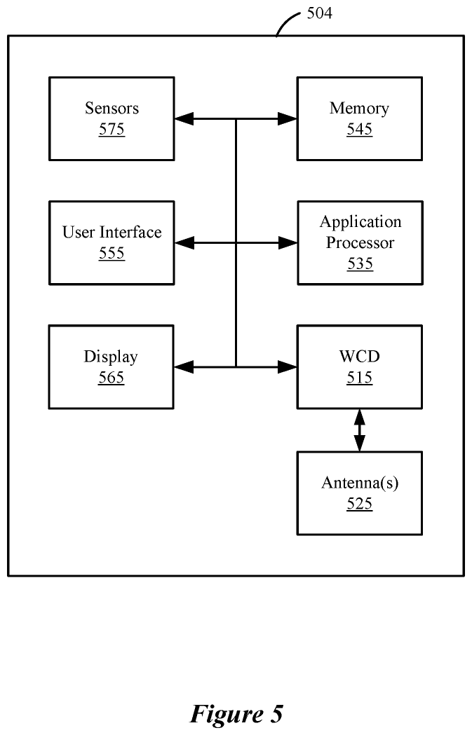

FIG. 5 shows a block diagram of an example STA 504. For example, the STA 504 can be an example implementation of the STA 304 described with reference to FIG. 3. The STA 504 includes a wireless communication device 515 (although the STA 504 may itself also be referred to generally as a wireless communication device as used herein). For example, the wireless communication device 515 may be an example implementation of the wireless communication device 400 described with reference to FIG. 4. The STA 504 also includes one or more antennas 525 coupled with the wireless communication device 515 to transmit and receive wireless communications. The STA 504 additionally includes an application processor 535 coupled with the wireless communication device 515, and a memory 545 coupled with the application processor 535. In some implementations, the STA 504 further includes a user interface (UI) 555 (such as a touchscreen or keypad) and a display 565, which may be integrated with the UI 555 to form a touchscreen display. In some implementations, the STA 504 may further include one or more sensors 575 such as, for example, one or more inertial sensors, accelerometers, temperature sensors, pressure sensors, or altitude sensors. Ones of the aforementioned components can communicate with other ones of the components directly or indirectly, over at least one bus. The STA 504 further includes a housing that encompasses the wireless communication device 515, the application processor 535, the memory 545, and at least portions of the antennas 525, UI 555, and display 565.

The following description describes example power save mechanisms for NAN devices. The examples are described with reference to a one-hop NDL including one NDP for a NAN device pair for clarity. However, a power save mechanism may be configured for one or more NDPs of an NDL of an NDC or other suitable configurations of a NAN network. Also in the examples, a time slot refers to 16 TUs. However, a time slot may be any suitable number of TUs. For example, a time slot may be any number of TUs from 1 to 16. In some implementations, operations may occur in the middle of a time slot. As such, a time slot may be organized into mini slots, which may be any suitable number of TUs less than the number of TUs of the time slot. For example, if a time slot is 16 TUs and a mini slot is 4 TUs, the time slot may include 4 mini slots. Also in the examples, a NAN device pair is described as being coupled over a single frequency spectrum (such as the 2.4 GHz frequency spectrum) for clarity. However, a NAN device pair may be configured to communicate over multiple frequency spectrums (such as both the 2.4 GHz frequency spectrum and the 5 GHz frequency spectrum). For example, a first set of discovery windows on a channel of the 2.4 GHz frequency spectrum (such as channel 6) may be used and a second set of discovery windows on a channel of the 5 GHz frequency spectrum (such as channel 149) may be used to negotiate different CRBs on the different frequency spectrums by the NAN device pair.

As described with reference to FIG. 3, a discovery window may occur periodically for a NAN device pair. In some implementations, the discovery window occurs every 32 time slots (512 TUs). As noted with reference to FIG. 3, the discovery window may be any suitable size, such as 16, 32, or 64 TUs. If the discovery window is 1 time slot (16 TUs), there exists 31 time slots between consecutive discovery windows (or 32 time slots of 16 TUs each existing between the beginnings of successive discovery windows). During a discovery window, the NAN device pair may negotiate an NDP between the NAN device pair, which may include one or more CRBs over the 31 time slots between discovery windows during which the NAN devices are available for NAN traffic between each other. The examples herein depict a single CRB for a discovery window interval for clarity. However, any suitable number of CRBs may exist. As used herein, a CRB also may be referred to as a common window or a window.

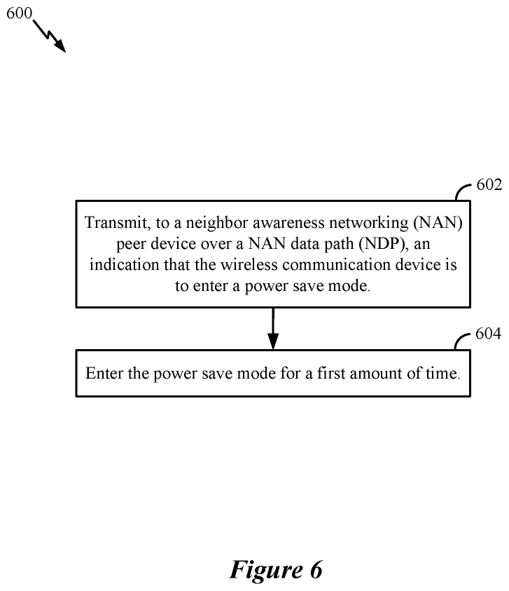

FIG. 6 shows a flowchart illustrating an example process 600 for power save in a NAN network. The process 600 is to be performed by the device indicating that the device is to enter a power save mode. The process 600 may be performed by a wireless communication device such as the wireless communication device 400 described herein with reference to FIG. 4. In some implementations, the process 600 may be performed by a wireless communication device operating as or within a STA, such as one of the STAs 304 described herein with reference to FIG. 3. While the process 600 may be performed by any suitable device, the process 600 is described as being performed by the wireless communication device 400 for clarity.

At 602, the wireless communication device transmits, to a NAN peer device over an NDP, an indication that the wireless communication device is to enter a power save mode. For example, during a CRB between the wireless communication device and the NAN peer device, the devices can transmit NAN packets to each other. Conventionally, the wireless communication device and the NAN peer device are to remain in an active mode during the entirety of the CRB. As used herein, a device being in an active mode may refer to the device being awake and able to receive wireless communications from other devices. A NAN device being in an active mode during a CRB may refer to the NAN device being awake and able to receive NAN packets from the NAN peer device.

If the wireless communication device has nothing to transmit, the wireless communication device may be configured to attempt to go into a power save mode. As used herein, a power save mode may refer to a mode in which one or more components of the interface or the processing system may be placed into a reduced power state. In some implementations, a power save mode may be the same as a low power mode or state as defined for IEEE 802.11 compliant devices. For example, at least a portion of the radio 406 and the modem 402 of the wireless communication device 400 may be powered down or otherwise placed into a low power mode to conserve power and processing resources. A wireless communication device in a low power mode is unable to transmit or receive NAN packets from a NAN peer device.

At 604, the wireless communication device enters the power save mode for a first amount of time. In some implementations, after transmitting the indication that the wireless communication device is to enter into the power save mode, a processing system of the wireless communication device causes the wireless communication device to enter into the power save mode. For example, the processor 404 (or another suitable processor) may execute instructions to cause one or more components of the radio 406, the modem 402, the processor 404, or the memory 408 to power down or otherwise enter into a low power mode during a CRB.

In some implementations, the wireless communication device may enter into a power save mode unilaterally without consideration from the NAN peer device. For example, after transmitting the indication to enter a power save mode, the wireless communication device may enter the power save mode without waiting for a response from the NAN peer device. Such an indication may be referred to as a unilateral trigger condition for entering the power save mode. The wireless communication device may enter into the power save mode immediately or a defined amount of time after the unilateral trigger condition.

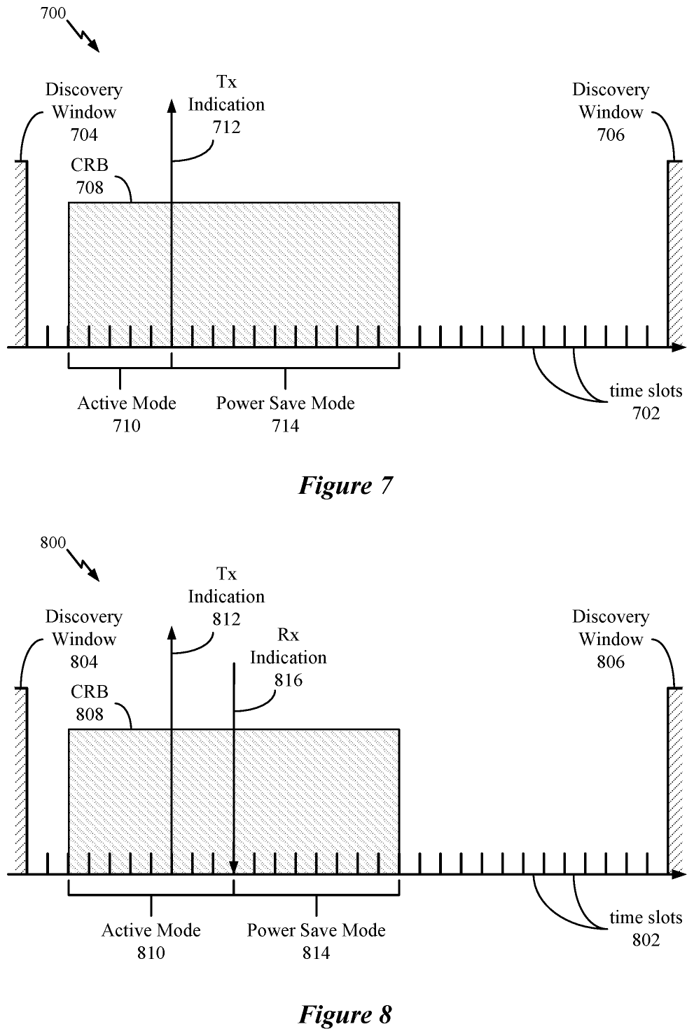

FIG. 7 shows an example timing diagram 700 of a wireless communication device entering into a power save mode after a unilateral trigger condition occurring over an NDP. The NDP is between the wireless communication device and a NAN peer device. The timing diagram 700 depicts a discovery window 704 ending after a first time slot 702 and a next discovery window 706 beginning 31 time slots after the discovery window 704 ends. The timing between the discovery windows 704 and 706 may be associated with a discovery window timer at each of the NAN devices. For example, the discovery window timer may be configured to count a defined amount of time (such as 32 time slots or another suitable amount of time) between the beginnings of discovery windows. The CRB 708 is 16 time slots that begins two time slots after the end of the discovery window 704. As described herein, the CRB 708 is agreed to between the wireless communication device and the NAN peer device through negotiation during a discovery window (such as the discovery window 704). As such, a CRB (such as a transmission block, which may include one or more time slots) may be negotiated to be in a range of 1 to 16 TUs. An example CRB 708 is depicted for clarity, but the position of the CRB, size of the CRB, and number of CRBs between discovery windows may be any suitable values as agreed to between the wireless communication device and the NAN peer device. NAN discovery beacons and other wireless communications that may exist are not depicted in the timing diagram 700 in FIG. 7 (or other timing diagrams in the figures) for clarity. While FIG. 7 (and FIG. 8) depict 31 time slots of 16 TUs each existing between discovery windows, a duration of a time slot may be any suitable number of TUs (such as 1 to 16 TUs). As such, the number of time slots between discovery windows may differ in accordance with the duration of a time slot. For example, if a time slot is 8 TUs, 62 time slots may exist between discovery windows (and each discovery window may be 2 time slots) such that the beginnings of successive time slots remain separated by 512 TUs.

Before transmitting the indication 712 that the wireless communication device is to enter into a power save mode, the wireless communication device and the NAN peer device may transmit one or more NAN packets to each other. For example, the wireless communication device may have data queued for the NAN peer device. The wireless communication device may begin the CRB 708 in an active mode, and the wireless communication device may send the data in one or more NAN packets at the beginning of the CRB 708. Additionally, or alternatively, the NAN peer device may transmit one or more NAN packets to the wireless communication device while the wireless communication device is in the active mode 710. In some other implementations, neither the wireless communication device nor the NAN peer device may have data queued for the other device at the beginning of the CRB 708. As such, no NAN packets may be transmitted between the devices while the wireless communication device is in the active mode 710.

At some point during the CRB 708, the wireless communication device may have no data queued for the NAN peer device and may not be receiving a transmission from the NAN peer device. The wireless communication device may be configured to indicate to the NAN peer device that the wireless communication device is to enter into a power save mode for a first amount of time. The wireless communication device may transmit such indication 712 to the NAN peer device and enter into a power save mode 714. As shown, the wireless communication device enters into the power save mode 714 without waiting for a response from the NAN peer device. While the wireless communication device is depicted as immediately entering into the power save mode, the wireless communication device may enter into the power save mode an amount of time after transmitting the indication 712 (such as following or in accordance with a short interframe spacing (SIFS) or another suitable amount of time).

The first amount of time that the wireless communication device is to be in the power save mode 714 is depicted in FIG. 7 to be until the end of the CRB 708 for clarity. However, the first amount of time to be in the power save mode may be any suitable amount of time defined between the wireless communication device and the NAN peer device. In addition, while the power save mode 714 is depicting as ending at the end of a time slot for clarity, the power save mode 714 may end at any agreed to time (which may be at the end of a time slot or in the middle of a time slot). As noted herein, a time slot may be 16 TUs. As such, a power save mode 714 may end at any TU of the 16 TUs of a time slot. In some implementations, a power save mode may end at the end of a mini slot of a time slot.

The amount of time that the wireless communication device is to be in the power save mode may be agreed to between the wireless communication device and the NAN peer device. For example, during setup of the NDP, the CRB 708 may be agreed to depending on, or associated with, timing schedules indicating the FAWs advertised by both the wireless communication device and the NAN peer device during a discovery window (with the CRB 708 based on the overlapping FAWs). In some implementations, the first amount of time is less than or equal to a maximum power save mode time associated with the NDP. The maximum power save mode time is the maximum amount of time that the wireless communication device may be in a power save mode. For example, the maximum power save mode time may be the length of the CRB, and the first amount of time may be the remaining amount of time in the CRB. The first amount of time or the maximum power save mode time set at the wireless communication device also may be set at the NAN peer device such that the time is the same for the devices of the NDP.

In some other implementations, the maximum power save mode time may be a different amount of time than the length of a CRB. In some implementations, each NAN device may be associated with a maximum power save mode time. For example, a power save mode time may be independently defined at each NAN device. For setup of an NDP, a NAN device may publish or subscribe to one or more services using SDFs. The SDFs also may be used to advertise one or more of whether a NAN device is configured to use a power save mechanism, the power save mechanism to be used (such as a unilateral trigger condition versus a mutually agreed trigger condition), or a power save mode time associated with the NAN device. For example, in one or more SDFs (or in another suitable manner), the wireless communication device may transmit, to the NAN peer device, an indication of a first power save mode time associated with the wireless communication device.

In some implementations, the first power save mode time associated with the wireless communication device may be associated with time slots during which the wireless communication device is to be in an active mode. For example, the longest FAW for the wireless communication device may be an “x” number of time slots (for any suitable integer x), and the first power save mode time may be x number of time slots. In another example, the shortest FAW for the wireless communication device may be a “y” number of time slots (for any suitable integer y), and the first power save mode time may be y number of time slots. In a further example, the wireless communication device may be configured to be awake during time slots to receive beacons at a specific beacon interval, and the first power save mode time may be associated with the beacon interval.

In some implementations, the time slots during which the wireless communication device is to be in an active mode may be associated with or in accordance with one or more of a latency requirement of data transmissions or a pattern of previous traffic intended for the wireless communication device. Regarding the first power save mode time being associated with or in accordance with the latency requirements for data transmissions, the NDP is associated with a specific service, and the service may be associated with a latency requirement for traffic between the wireless communication device and the NAN peer device. For example, best effort traffic for a first service may have less stringent latency requirements than high importance traffic for a second service. As such, the wireless communication device may be allowed to remain in a power save mode for a longer amount of time for an NDP associated with the first service than for an NDP associated with the second service. In some implementations, the first power save mode time may be associated with the service associated with the NDP and corresponding latency requirements for data transmissions. The association between the service or latency requirement and the first power save mode time may be defined in any suitable manner.

Regarding the first power save mode time being associated with a pattern of previous traffic intended for the wireless communication device, the wireless communication device may be configured to track when traffic intended for the wireless communication device is received at the wireless communication device. For example, the wireless communication device may identify which time slots over a last m number of time slots that the wireless communication device receives a frame addressed to or otherwise intended for the wireless communication device. In some implementations, the first power save mode time may be associated with the largest gap of time slots between identified time slots. In some implementations, the first power save mode time may be associated with an average interval of time slots between identified time slots. The association between the pattern of previous traffic and the first power save mode time may be defined in any suitable manner. For example, in accordance with a power save mode being associated with time intervals between identified slots, power save time may be associated with whether a transmission opportunity period includes contiguous or non-contiguous transmission blocks.

In some implementations, for example, the wireless communication device may enter a power save mode during time periods between non-contiguous transmission blocks (such as non-contiguous blocks of time during which the wireless communication and the NAN peer device may transmit to each other), where such a time period between non-contiguous transmission blocks may be referred to herein as non-transmission blocks (such as non-transmission blocks of time, or blocks of time without transmissions between the wireless communication device and the NAN peer device). In some aspects, the wireless communication device and the NAN peer device may negotiate and indicate when (such as at what time) the wireless communication device is to enter a power save mode during non-transmission blocks (such as ones that are non-contiguous) in accordance with the wireless communication device and the NAN peer device using non-contiguous transmission blocks (such as in accordance with the one or more blocks of time during which both the wireless communication device and the NAN peer device are available being non-contiguous). As such, the wireless communication device and the NAN peer device may perform one or more activities or operations, including entering a power save mode, between transmission blocks (such as between the one or more blocks of time during which both the wireless communication device and the NAN peer device are available). In other words, between transmission blocks (such as one or more blocks of time), peers may enter a power save mode.

In one or more other SDFs (or in another suitable manner), the wireless communication device may receive, from the NAN peer device, an indication of a second power save mode time associated with the NAN peer device. The second power save mode time may be defined in any suitable manner, such as similar to how the first power save mode time is defined. In some implementations, the wireless communication device and the NAN peer device are configured to negotiate the maximum power save mode time as a minimum from the first power save mode time and the second power save mode time. In some other implementations, the wireless communication device and the NAN peer device may be configured to select the maximum from the first power save mode time and the second power save mode time, or the maximum power save mode time may be calculated in any other suitable manner.

Referring back to FIG. 7, if the maximum power save mode time is less than the remainder of the CRB 708, the wireless communication device may return to an active mode at the end of the maximum power save mode time. As such, the wireless communication device and the NAN peer device may transmit one or more NAN packets to each other during the remainder of the CRB 708.

While the power save mode time is depicted as being associated with the CRB for clarity, in some implementations, the power save mode time may span outside of the CRB (such as anywhere up to the next discovery window). For example, a power save mode may span multiple CRBs or other time slots outside of a current CRB as long as the power save mode ends before the next discovery window.

A unilateral trigger condition for entering a power save mode by the wireless communication device may be indicated in any suitable manner to the NAN peer device. The format of the packets transmitted between the NAN devices may conform to one or more of the IEEE 802.11 sets of standards. For example, transmitting a NAN frame or a NAN packet between NAN devices may refer to the NAN devices transmitting a PDU including a MAC packet in the payload of the PDU (such as PHY payload 204 of PDU 200). A MAC packet includes a MAC header, and the MAC header includes a Frame Control (FC) field. The FC field includes a power management (PM) bit. In a WLAN 100 including an AP 102, the PM bit may be used to indicate that a device is going to sleep.

In some implementations, the indication to a NAN peer device that the wireless communication device is to enter into a power save mode includes a MAC packet with the PM bit set to 1. For example, referring back to FIG. 7, the indication 712 transmitted from the wireless communication device to the NAN peer device may include a MAC data packet whose header's FC field includes the PM bit set to 1. While the PM bit set to 1 is provided as an example unilateral indicator of entering into a power save mode, any other suitable indicator may be used. For example, a specific bit in the payload of the MAC packet or another suitable bit may be used to indicate that the wireless communication device is to enter into a power save mode.

In contrast to a unilateral trigger condition, in some implementations, the wireless communication device may enter into a power save mode when mutually agreed upon with the NAN peer device. For example, after transmitting the indication to enter a power save mode, the wireless communication device waits for a response from the NAN peer device before entering into the power save mode. Such an indication may be referred to as a mutually agreed trigger condition for entering the power save mode. The wireless communication device immediately may enter into the power save mode a defined amount of time after transmitting the indication (referred to as a dwell time) or after receiving an indication that the NAN peer device agrees to the wireless communication device entering into the power save mode.

FIG. 8 shows an example timing diagram 800 of a wireless communication device entering into a power save mode after a mutually agreed condition occurring over an NDP. The NDP is between the wireless communication device and a NAN peer device. Similar to the timing diagram 700 in FIG. 7, the timing diagram 800 depicts a discovery window 804 ending after a first time slot 802 and a next discovery window 806 beginning 31 time slots after the discovery window 804 ends (with the beginnings of the discovery windows 804 and 806 separated by 32 time slots (512 TUs)). The CRB 808 is 16 time slots that begins two time slots after the end of the discovery window 804. The CRB 808 may be agreed to between the wireless communication device and the NAN peer device through negotiation during a discovery window (such as the discovery window 804). An example CRB 808 is depicted for clarity, but the position of the CRB, size of the CRB, and number of CRBs between discovery windows may be any suitable values as agreed to between the wireless communication device and the NAN peer device. NAN discovery beacons and other wireless communications that may exist are not depicted in the timing diagram 800 in FIG. 8 for clarity.

At some point during the CRB 808, the wireless communication device may have no data queued for the NAN peer device. The wireless communication device may be configured to indicate to the NAN peer device that the wireless communication device is to enter into a power save mode. The wireless communication device may transmit such indication 812 to the NAN peer device. The indication 812 is associated with a mutually agreed trigger condition. As such, the wireless communication device may wait for a response from the NAN peer device before entering into a power save mode 814. As shown, the wireless communication device remains in the active mode 810 after transmitting the indication 812.

In some implementations, the wireless communication device remains in an active mode during a dwell time after transmitting the indicating. For example, the processing system of the wireless communication device may cause the wireless communication device to remain in an active mode up to a dwell time to wait for the response from the NAN peer device. In FIG. 8, the wireless communication device receives the indication 816 from the NAN peer device over the NDP indicating that the wireless communication device may enter into the power save mode. For example, the interface of the wireless communication device may be configured to receive the indication from the NAN peer device. For the NAN peer device to transmit the indication 816, the NAN peer device may have no additional data queued for the wireless communication device or otherwise does not require transmitting data to the wireless communication device. The NAN peer device's indication that the wireless communication device is to enter the power save mode may indicate that there is not data to be transmitted to the wireless communication device.

After receiving the indication 816, the wireless communication device enters into the power wave mode 814. For example, the processing system of the wireless communication device is configured to cause the wireless communication device to enter the power save mode in response to receiving the indication 816. In some implementations, the processing system of the wireless communication device 400 (or another suitable processing system) may execute instructions to cause one or more components of the interface (such as the modem 402 or the radio 406) or the processing system (such as the processor 404, the modem 402, or the memory 408) to be powered off or otherwise enter a low power state.

Similar to as described with reference to FIG. 7, while the power save mode 814 is depicted as ending at the end of the CRB 808, the power save mode 814 may end at any suitable time agreed to between the wireless communication device and the NAN peer device. As such, the power save mode 814 may end before the end of the CRB 808, or the power save mode 814 may end after the CRB 808. The power save mode 814 may end at the end of a time slot or during any TU of a time slot. At the end of the power save mode 814, the wireless communication device may return to an active mode.

As noted herein, whether the wireless communication device is configured for power save, what type of power save may be used, or the amount of time (such as a maximum power save mode time) that the wireless communication device is to be in a power save mode may be negotiated with the NAN peer device during setup of the NDP (such as during a discovery window). In some implementations, a dwell time also may be negotiated between the wireless communication device and the NAN peer device during setup of the NDP. For example, one or both of the wireless communication device or the NAN peer device may advertise a dwell time associated with the NAN device (such as in one or more SDFs). The devices may negotiate an agreed to dwell time (such as during a discovery window) in accordance with the advertising of the dwell time. An example dwell time may be a minimum from, a maximum from, or an average of the dwell times associated with the wireless communication device and the NAN peer device. However, any suitable dwell time may be negotiated between the wireless communication device and the NAN peer device. In some implementations, a dwell time is associated with the CRB. For example, different CRBs may include different wireless channels to be used, and congestion may be channel dependent. As such, a NAN device may be associated with different dwell times corresponding to different wireless channels or different CRBs. A NAN device may advertise a dwell time for each CRB or negotiate a common dwell time for each CRB.

To manage a dwell time at the wireless communication device, the wireless communication device may include a dwell time counter configured to count the time up to the dwell time. The wireless communication device may identify when the dwell time has completed in accordance with the counter counting up to the dwell time. For example, when the wireless communication device transmits the indication 812 to the NAN peer device, the wireless communication device may initiate the dwell time counter to start counting towards the dwell time (such as counting up from zero to an amount corresponding to the dwell time or counting down from the amount to zero). The dwell time expires when the dwell time counter reaches zero (if counting down) or the amount corresponding to the dwell time (if counting up). In some implementations, negotiating the dwell time may include negotiating the value of the dwell time counter to be used. As noted, the wireless communication device may be configured to stay in an active mode up to the dwell time after transmitting the indication 812. In some implementations, the wireless communication device is to remain idle during the dwell time. The wireless communication device remaining idle may refer to the wireless communication device not transmitting to another device.

Any suitable indication for a mutually agreed trigger condition that the wireless communication device is to enter into a power save mode may be transmitted by the wireless communication device to the NAN peer device. For example, as noted herein, the format of the packets transmitted between the NAN devices may conform to one or more of the IEEE 802.11 sets of standards. For example, transmitting a NAN frame or a NAN packet between NAN devices may refer to the NAN devices transmitting a PDU including a MAC packet in the payload of the PDU (such as PHY payload 204 of PDU 200). The FC field of a MAC header of the MAC packet includes a more data (MD) bit.

In some implementations, the indication 812 transmitted to a NAN peer device includes a MAC packet with the MD bit in the FC field of the MAC header set to 0. For example, the interface of the wireless communication device may be configured to transmit a MAC packet with the MD bit set to 0. While MAC packet including the MD bit set to 0 is provided as an example of a mutually agreed indicator, any other suitable indicator may be used. For example, a specific bit in the payload of the MAC packet or another suitable bit may be used to indicate that the wireless communication device is to enter into a power save mode if agreed to by the NAN peer device.

The indication 816 received from the NAN peer device may be similar to the indication 812. In some implementations, the indication 816 indicating that the NAN peer device is to allow the wireless communication device to enter the power save mode may include a MAC packet with a MD bit in the FC field of the MAC header set to 0. The MD bit set to 0 in the indication 816 may indicate that the NAN peer device has no data queued to be transmitted to the wireless communication device or otherwise does not require the wireless communication device to remain in an active power mode.

As noted herein, if the trigger condition is a mutually agreed trigger condition for entering into a power save mode (such using the MD bit in a MAC packet), the wireless communication device may be configured to remain in an active mode up to a dwell time after transmitting the indication to enter into a power save mode. The dwell time may be a defined amount of time to allow the NAN peer device to receive the indication from the wireless communication device and transmit a response such that the wireless communication device receives the response before the end of the dwell time.

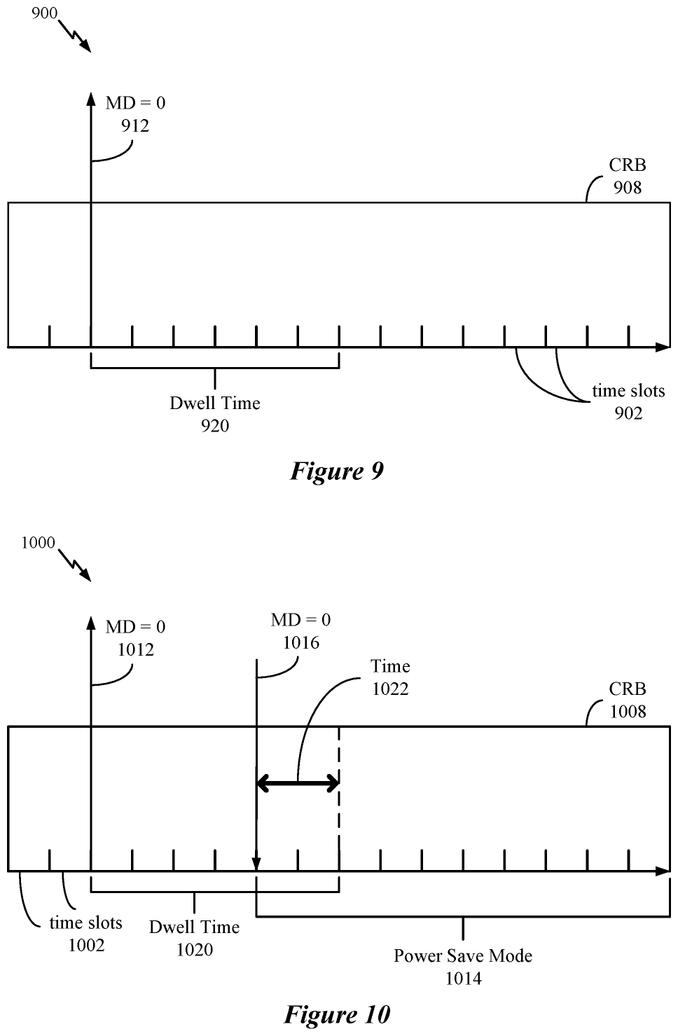

FIG. 9 shows an example timing diagram 900 of a wireless communication device waiting a dwell time 920 after transmitting an indication 912 to enter a power save mode. For the CRB 908 of an NDP setup between the wireless communication device and a NAN peer device, the wireless communication device may be in an active mode at the beginning of the CRB 908. While not shown in FIG. 9, if the wireless communication device or the NAN peer device has data queued for the other device, the data may be transmitted to the other NAN device at the beginning of the CRB 908.

The wireless communication device transmits an indication 912 that the wireless communication device is to enter into a power save mode (including a MAC data packet with the MD bit set to 0). While the indication 912 is shown as being transmitted multiple time slots 902 into the CRB 908, the indication 912 may be transmitted at any suitable time in the CRB 908. In some implementations, if the wireless communication device has no data queued for the NAN peer device, the wireless communication device may contend for the wireless channel of the NDP at the beginning of the CRB 908 to transmit a MAC data packet with the MD bit set to 0. In some implementations, the wireless communication device may contend for the wireless channel to transmit the MAC data packet with the MD bit set to 0 as soon as no more data is queued for the NAN peer device (which may occur in the middle of the CRB 908). In some implementations, if the wireless communication device has no data queued for the NAN peer device, the wireless communication device may wait a defined amount of time before accessing the wireless channel to transmit the MAC data packet with the MD bit set to 0.

After transmitting the indication 912, the wireless communication device is to wait in the active mode for the dwell time 920. As noted herein, the dwell time 920 may be negotiated between the wireless communication device and the NAN peer device. During the dwell time 920, the wireless communication device may remain idle (without attempting to transmit). While the wireless communication device is idle, the wireless communication device may listen to the wireless channel of the NDP for an indication from the NAN peer device. In some implementations, the wireless communication device also may listen for traffic intended for the wireless communication device.

In some instances, the wireless communication device may not receive traffic intended for the wireless communication device or an indication from the NAN peer device. For example, an indication from the NAN peer device may not be received by the idle wireless communication device before the end of the dwell time 920. If no traffic intended for the wireless communication device is received and no indication from the NAN peer device is received during the dwell time 920, the wireless communication device may enter into a power save mode at the end of the dwell time 920. For example, if the dwell time counter counts to zero or to the amount associated with the dwell time (thus reaching the dwell time), the processing system of the wireless communication is configured to cause the wireless communication device to enter the power save mode for the first amount of time. As noted herein, the first amount of time may be any suitable amount of time equal to or less than a maximum power save mode time. For example, the first amount of time may be until the end of the CRB 908, a negotiated time that ends before the end of the CRB 908, or another suitable time that ends before the next discovery window.

If the wireless communication device receives an indication from the NAN peer device before the end of the dwell time 920 that the wireless communication device may enter the power save mode, the wireless communication device may enter the power save mode before the entirety of the dwell time 920 passes. As such, the wireless communication device may end the dwell time in response to receiving an indication that the wireless communication device is to enter a power save mode.

FIG. 10 shows an example timing diagram 1000 of a wireless communication device ending a dwell time 1020 in response to receiving an indication 1016 that the wireless communication device is to enter a power save mode 1014. The CRB 1008 (which includes a plurality of time slots 1002) may be similar to the CRB 908 in FIG. 9, with the indication 1012 being transmitted to the NAN peer device and the wireless communication device being idle and in an active mode during the dwell time 1020. Before the end of the dwell time 1020, the wireless communication device receives an indication 1016 (such as a MAC packet with the MD bit set to 0) from the NAN peer device indicating that the wireless communication device is to enter the power save mode.

In some implementations, the indication 1016 may include a Quality of Service (QoS) null data packet with the MD bit of the FC field of the MAC header set to 0 to indicate that the wireless communication device is to enter the power save mode. In some implementations, the indication 1016 may include a MAC data packet with the MD bit set to 0. For example, the NAN peer device may have data queued to transmit to the wireless communication device, and the queue empties for a last MAC data packet to the wireless communication device. The NAN peer device may set the MD bit to 0 in the last MAC data packet to indicate that no further data is to be transmitted to the wireless communication device. As such, the wireless communication device may receive and process the MAC data packet, and in response to the MD bit being set to 0, the wireless communication device may enter the power save mode.

In response to receiving the indication 1016, the wireless communication device may enter the power save mode 1014. As shown, the power save mode 1014 may begin a time 1022 before the end of the dwell time 1020. In some implementations, the wireless communication device ends the dwell time 1020 in response to receiving the indication 1016. For example, the processing system of the wireless communication device may be configured to stop and reset the dwell time counter and proceed with causing the wireless communication device to enter the power save mode 1014 in response to receiving the indication 1016. In some implementations, the time 1022 that the dwell time 1020 is shortened may be added by the wireless communication device to the amount of time that the wireless communication device is to be in the power save mode 1014.

While the power save mode 1014 is depicted as ending at the end of the CRB 1008 for clarity, the power save mode 1014 may end at any suitable time. For example, the power save mode 1014 may end after an agreed upon amount of time (which may differ from the end of the CRB 1008). After the power save mode 1014, the wireless communication device may return to an active mode.

In some instances, the NAN peer device may need to prevent the wireless communication device from entering a power save mode. For example, the NAN peer device may have data queued for the wireless communication device when the NAN peer device receives a MAC packet with the MD bit set to 0 from the wireless communication device. As such, the NAN peer device may transmit over the NDP, and the wireless communication device may receive, an indication to prevent the wireless communication device from entering the power save mode. In some implementations, the indication may include a MAC packet from the NAN peer device to the wireless communication device with the MD bit in the FC field of the MAC header set to 1. The MD bit being set to 1 may indicate that the NAN peer device has data to be transmitted to the wireless communication device or otherwise requires the wireless communication device to remain in an active mode. As such, if the wireless communication device receives an indication of a MD bit set to 1 in a MAC packet during the dwell time, the wireless communication device may prevent entering into the power save mode. In some implementations, the MAC packet with the MD bit set to 1 may be a MAC data packet including data being transmitted from the NAN peer device to the wireless communication device. While the NAN peer device has additional data to be transmitted to the wireless communication device, each successive MAC data packet may have the MD bit set to 1. For the last MAC data packet from the NAN peer device (with no further data queued for transmission to the wireless communication device or otherwise not needing the wireless communication device to remain awake), the MD bit may be set to 0 to indicate that the wireless communication device is to enter the power save mode.

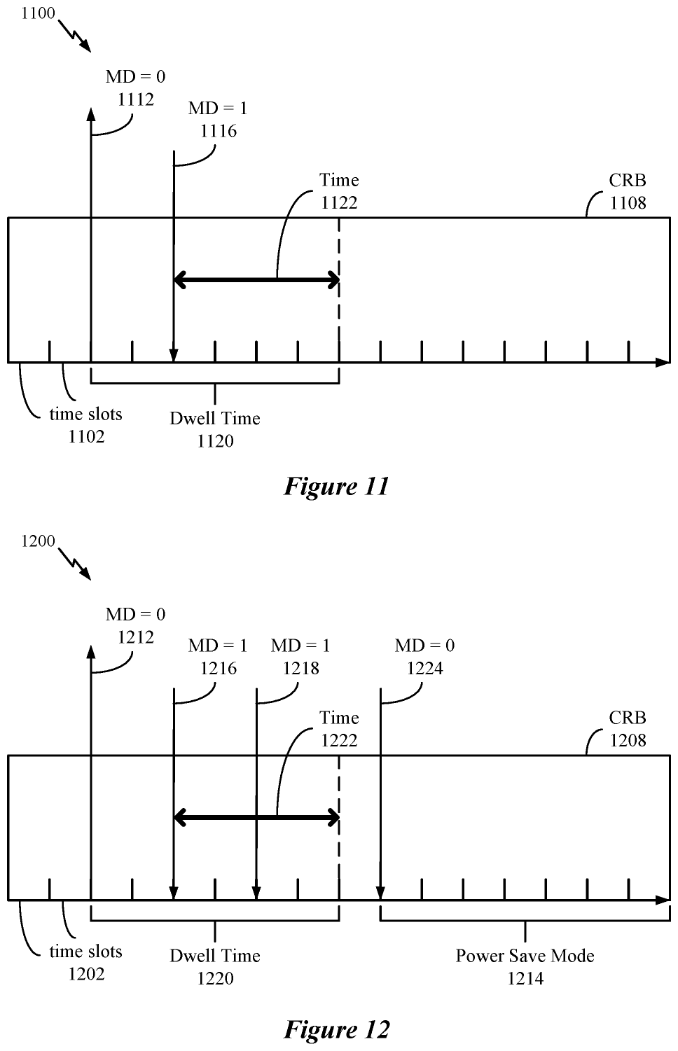

FIG. 11 shows an example timing diagram 1100 of a wireless communication device preventing entering a power save mode in response to receiving an indication 1116 to prevent entering the power save mode. The CRB 1108 (including a plurality of time slots 1102) of an NDP between the wireless communication device and the NAN peer device may be similar to the CRB 908 in FIG. 9 and the CRB 1008 in FIG. 10. The wireless communication device and the NAN peer device previously may have negotiated the dwell time 1120 to be used, a power save mode time to be used, and other characteristics of the NDP.

With the wireless communication device having no data to be transmitted to the NAN peer device, the wireless communication device may transmit indication 1112 to enter into a power save mode (such as transmitting a MAC packet with the MD bit set to 0. The wireless communication device is configured to remain in an active mode during the dwell time 1120 after transmitting the indication 1112 (which may be timed using the dwell time counter). The wireless communication device may be idle after transmitting the indication 1112. The NAN peer device may receive the indication 1112 and transmit an indication 1116 in response that the NAN peer device requires the wireless communication device to remain in the active mode. During the dwell time, the wireless communication device receives the indication 1116 (such as a MAC packet with the MD bit set to 1) to prevent the wireless communication device from entering the power save mode. In some implementations, the indication 1116 includes a QoS null data packet with the MD bit set to 1. In some implementations, the indication 1116 includes a MAC data packet with the MD bit set to 1. If a MAC data packet is used, the wireless communication device also may receive data with the indication 1116 from the NAN peer device.

In response to receiving the indication 1116, the wireless communication device may end the dwell time. As such, time 1122 from when receiving the indication 1116 to the end of the dwell time 1120 may be removed from dwell time 1120. For example, the processing system of the wireless communication device may stop and reset the dwell time counter and cause the wireless communication device to remain in an active mode during time 1122 and further into the CRB 1108. In the active mode, the wireless communication device may be allowed to transmit to the NAN peer device if data becomes ready for transmission to the NAN peer device. As such, the wireless communication device may not remain idle after receiving the indication 1116 (such as during time 1122).

In some implementations, the wireless communication device may restart counting the dwell time after receiving the indication 1116. For example, after the wireless communication device receives a QoS null data packet or a MAC data packet with the MD bit set to 1, the wireless communication device may restart the dwell time counter after resetting the dwell time counter. In this manner, the wireless communication device may begin to count the dwell time from receiving the indication 1116. If another packet is not received during the dwell time, the wireless communication device may enter the power save mode. In some implementations, the wireless communication device may restart the dwell time counter after each indication that the wireless communication device is to remain in an active mode (such as after each packet with the MD bit set to 1 is received).

In some implementations, after the NAN peer device indicates that the wireless communication device is to remain in the active mode, the NAN peer device may indicate that the wireless communication device is to enter the power save mode. For example, if all data queued for the wireless communication device is transmitted in data packets from the NAN peer device to the wireless communication device such that the NAN peer device has no further data to transmit to the wireless communication device, the NAN peer device may indicate that the wireless communication device may enter into the power save mode.

FIG. 12 shows an example timing diagram 1200 of a wireless communication device entering a power save mode 1214 after previously being prevented from entering the power save mode. The CRB 1208 (including a plurality of time slots 1202) of an NDP between the wireless communication device and a NAN peer device may be similar to the CRB 1108 in FIG. 11. For example, the indication 1212 may be the same as the indication 1112 in FIG. 11, the dwell time 1220 may be the same as the dwell time 1120 in FIG. 11, the indication 1216 may be the same as the indication 1116 in FIG. 11, and the time 1222 may be the same as the time 1122 in FIG. 11.

As depicted, the wireless communication device receives, from the NAN peer device, one or more indications (such as indications 1218 and 1224) subsequent to the indication 1216. For example, the NAN peer device may have additional data to transmit to the wireless communication device after transmitting the indication 1216, and the NAN peer device may transmit one or more data packets to the wireless communication device. Each packet transmitted to the wireless communication device may include the MD bit of a MAC header set to 0 or 1. The MD bit set to 1 indicates that additional data is to be transferred to the wireless communication device or otherwise that the wireless communication device is to remain in an active mode to receive packets. For example, the indication 1218 may be a MAC data packet with the MD bit set to 1 to indicate that additional MAC data packets are to be received. As noted herein, the wireless communication device may restart the dwell time counter (or otherwise time the dwell time) after each packet with the MD bit set to 1 is received. If no data packets are to be transmitted in the future by the NAN peer device, the last MAC data packet may include the MD bit set to 0. For example, the indication 1224 may be a MAC data packet with the MD bit set to 0 to indicate that the wireless communication device is to enter a power save mode 1214. In another example, the indication 1224 may be a QoS null data packet with the MD bit set to 0. While one indication 1218 is depicted as existing between indications 1216 and 1224, any number of indications may be received by the wireless communication device. For example, a plurality of MAC data packets from the NAN peer device may be received before receiving the indication 1224. In some other implementations to receiving indication 1224 (which may include a packet with the MD bit set to 0), the NAN peer device may not transmit a packet with the MD bit set to 0 or such a packet transmitted by the NAN peer device may not be received by the wireless communication device as a result of fading or other interference. If the wireless communication device is counting the dwell time after receiving the last packet with the MD bit set to 1, the wireless communication device may enter into the power save mode in response to reaching the end of the dwell time.

After transmitting the indication 1212 and in response to receiving the indication 1224, the wireless communication device may enter the power save mode 1214. As described herein, the power save mode 1214 may be for any suitable amount of time. For example, the power save mode 1214 may be for a maximum power save mode time negotiated between the wireless communication device and the NAN peer device. In another example, the power save mode 1214 may be for the remainder of the CRB 1208, which may be less than or equal to the maximum power save mode time. While the power save mode 1214 is depicted as ending at the end of the CRB 1208, the power save mode 1214 may end at any suitable time before the next discovery window.

While a MAC packet including an MD bit set to 0 or 1 is described as an indication from the NAN peer device, any suitable indication defined at both the wireless communication device and the NAN peer device may be used (such as a different defined bit in the MAC packet payload or another suitable indicator being used). For example, the NAN peer device may transmit a MAC packet with the PM bit set to 1, a defined bit of the MAC packet payload set to 1, or any other suitable indicator in response to receiving a MAC packet with the MD bit set to 0 and to indicate that the wireless communication device is to enter into or remain out of a power save mode.

In addition or alternative to receiving a MAC packet with an MD bit set to 1 (or another suitable indication) to prevent the wireless communication device from entering into a power save mode, the wireless communication device may receive data intended for the wireless communication device during the dwell time. For example, the NAN peer device (or another device) may transmit one or more data packets addressed to or otherwise intended for the wireless communication device during the dwell time. In another example, the wireless communication device may be a proxy in an NDL and is to receive and transmit NAN packets between NAN peer devices. The wireless communication device receiving the intended data during the dwell time may cause the wireless communication device to prevent entering into the power save mode (and thus remain in an active mode). As described herein, the wireless communication device may be idle during the dwell time. If the wireless communication device receives data from another device or receives an indication from the NAN peer device to remain in the active mode, the wireless communication device is not required to remain idle. For example, the wireless communication device may transmit to the NAN peer device if data becomes queued for the NAN peer device while the wireless communication device is in the active mode.

As described herein, the dwell time is negotiated between the wireless communication device and the NAN peer device during setup of the NDP. In some implementations, the dwell time may be adjustable in accordance with or depending on a congestion on a portion of the wireless medium including the NDP. For example, in setting up the NDP, the wireless communication device and the NAN peer device negotiate the wireless channel to use. The dwell time to be used by the wireless communication device and the NAN peer device may be adjusted depending on a congestion on the wireless channel of the NDP. Congestion may refer to potential interference on the wireless medium (such as on the wireless channel of the NDP). Congestion may be impacted by the number of wireless devices transmitting over the wireless medium (such as in the same frequency range as the wireless channel of the NDP). Congestion also may be impacted by the transmit power of the transmissions and proximity of the other devices to the NAN devices. Congestion also may be impacted by devices other than wireless devices that emit interference in the same frequency spectrum. For example, microwaves emit radiation that may interfere with wireless communications in the 2.4 GHz frequency spectrum.

If there is congestion on the wireless channel of the NDP, a NAN peer device may not receive and accurately decode an indication from the wireless communication device and vice versa as a result of the congestion. Assuming all other factors are the same, as the congestion on the wireless medium increases, the likelihood that a transmitted indication is received decreases. Conversely, as the congestion on the wireless medium decreases, the likelihood that a transmitted indication is received increases. Congestion also may prevent a NAN device from obtaining control of the wireless channel in order to transmit an indication (or NAN packets in general). As noted herein, the dwell time may be an amount of time to take into account the time needed for a NAN device to receive and transmit an indication with a NAN peer device. If congestion prevents a NAN device from receiving an indication or prevents the NAN device from obtaining access to a wireless channel to transmit an indication, the previously negotiated dwell time may be too short in light of the congestion. Conversely, if congestion does not exist or is reduced, the dwell time may be too long in light of the lack of congestion. As such, a NAN device may be configured to adjust the dwell time to take into account congestion (or lack of congestion) on the wireless medium including the NDP (such as congestion on the wireless channel of the NDP).

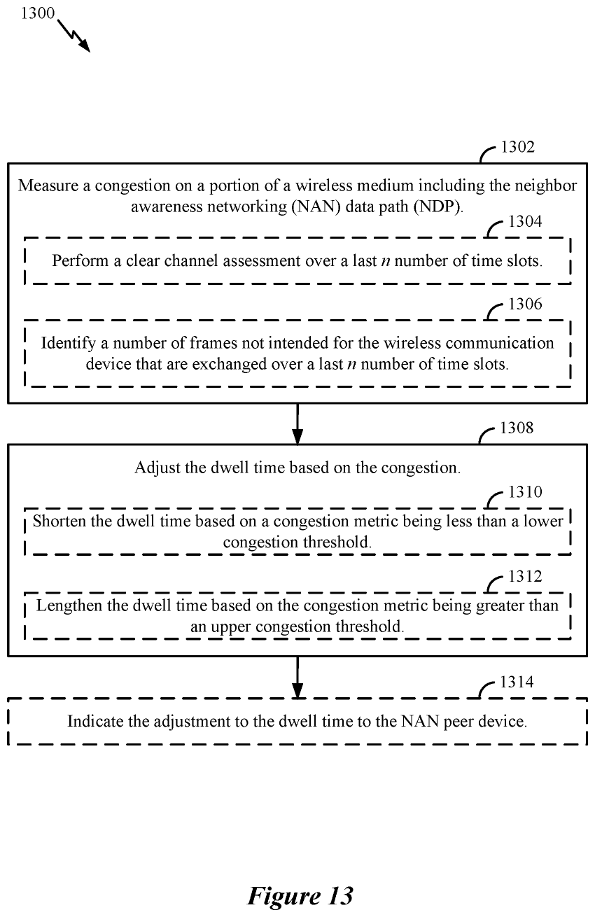

FIG. 13 shows a flowchart illustrating an example process 1300 for adjusting a dwell time. The process 600 may be performed by any NAN device in an NDC (such as either device of a NAN device pair). The process 1300 may be performed by a wireless communication device such as the wireless communication device 400 described herein with reference to FIG. 4. In some implementations, the process 1300 may be performed by a wireless communication device operating as or within a STA, such as one of the STAs 304 described herein with reference to FIG. 3. While the process 1300 may be performed by any suitable device, the process 1300 is described as being performed by the wireless communication device 400 for clarity.

At 1302, the wireless communication device measures a congestion on a portion of a wireless medium including the NDP. For example, as described herein, the NDP may include the wireless channel over which the wireless communication device and the NAN peer device are to communicate. Measuring the congestion on the portion of the wireless medium including the NDP may include measuring the congestion on the wireless channel of the NDP.

The wireless communication device may be configured to measure a congestion during a dwell time. For example, referring back to FIG. 9, if the wireless communication device is to remain idle during the dwell time 920, the wireless communication device may measure the congestion during the dwell time 920. The congestion may be measured over an “n” number of time slots (for any suitable integer n). The integer n may indicate a number of time slots less than or equal to a dwell time or that may span multiple dwell times. Any suitable integer n may be defined at the wireless communication device in any suitable manner (such as being defined by a device manufacturer, being indicated by a user, being negotiated during setup of the NDP, and so on).

Referring back to FIG. 13, in some implementations, measuring the congestion may include performing a CCA over a last n number of time slots (1304). For example, CCA may include energy detection during physical carrier sensing. As such, performing the CCA over the last n number of time slots may include measuring the energy existing on the wireless channel during the last n number of time slots. The wireless channel may be identified as being busy during a time slot if the measured energy during the time slot is greater than an energy threshold. As such, the wireless communication device may select, identify, ascertain, or otherwise determine the number of time slots during which the wireless channel is idle or the number of time slots during which the wireless channel is busy over the last n number of time slots. In some implementations, measuring the congestion may include generating a congestion metric. An example congestion metric may include the number of time slots that the wireless channel is busy (such as integer b) divided by the total number of time slots measured (integer n). In this manner, an example congestion metric may be b/n. However, any suitable congestion metric may be generated in accordance with or using the energy detected on the wireless medium.

As noted herein, congestion may be caused by interference other than wireless packets on the wireless medium (such as interference on the 2.4 GHz frequency spectrum caused by a microwave). Such interference may be smaller lasting and less frequent than wireless packets being transmitted on the wireless medium. For example, a microwave may be used for less than a minute a few times a day, but another wireless device may be using the wireless medium constantly throughout the day. Using energy detection to identify when a wireless channel is busy may not take into account the different types of interference. In some implementations, it may be beneficial to differentiate between wireless traffic from wireless devices and interference from other devices that may cause congestion. For example, detecting valid frames on the wireless channel in addition or alternative to detecting an energy may be used in measuring a congestion on the wireless channel.

In some implementations, measuring the congestion may include identifying a number of frames not intended for the wireless communication device that are exchanged over a last n number of time slots (1306). For example, the wireless communication device may listen to the wireless channel of the NDP each time slot of the last n number of time slots, receive any frame being transmitted on the wireless channel during each time slot, process the header of any received frame, and identify, ascertain, or otherwise determine if the frame is addressed to or otherwise intended for the wireless communication device. If a frame is received during a time slot, the wireless communication device may identify that the wireless channel is busy for the time slot. As such, the wireless communication device may identify the number of time slots that the wireless channel is busy out of the last n number of time slots. In some implementations, the wireless communication device also may measure the energy of the received frame and compare the measured energy to an energy threshold. The wireless channel being busy during a time slot may include a frame being received during the time slot with an energy of the packet including the frame being greater than an energy threshold. As noted herein, an example congestion metric may include the number of time slots that the wireless channel is busy (such as integer b) divided by the total number of time slots measured (integer n). In this manner, an example congestion metric may be b/n. However, any suitable congestion metric may be generated in accordance with packets being received during the last n number of time slots.

As noted herein, measuring congestion may be performed during the dwell time. As depicted in step 1306, the frames that are identified by the wireless communication device are not intended for the wireless communication device. For example, in processing the frame headers, the wireless communication device may identify that the frames are addressed to a device other than the wireless communication device. If a frame is addressed to the wireless communication device or is otherwise intended for the wireless communication device, the wireless communication device is receiving data during the dwell time. As described herein, the wireless communication device receiving data during the dwell time may cause the wireless communication device to end the dwell time and remain in an active mode. As such, measuring the congestion in step 1306 may be associated with or otherwise involve frames not intended for the wireless communication device.

At 1308, the wireless communication device may adjust the dwell time in accordance with the congestion. In some implementations, adjusting the dwell time includes adjusting the dwell time counter value associated with the dwell time. In this manner, the dwell time counter may count a different length dwell time. Adjusting the dwell time may be in accordance with a congestion metric generated by the wireless communication device in step 1302. For example, the congestion metric is to be bounded by one or both of a lower congestion metric or an upper congestion metric. In some implementations, the wireless communication device may shorten the dwell time in accordance with the congestion metric being less than the lower congestion threshold (1310). The congestion metric being less than a lower congestion threshold may indicate that the congestion is less than desired for the current dwell time. As such, the current dwell time may be too long, thus causing the wireless communication device to remain in the active mode for longer than needed.

Shortening the dwell time may be performed in any suitable manner. For example, the dwell time may be shortened by an amount of time defined at the wireless communication device. The shortened dwell time may be used the next time a power save indication is transmitted or received (such as during a new CRB). If no congestion exists on the wireless channel for an extended amount of time, the wireless communication device may recursively measure the congestion during an ever shortening dwell time and shorten the dwell time (which may be depicted as shortening the dwell time in a stepwise manner over time).

The steps in shortening the dwell time may be fixed or variable. In some implementations, the dwell time may be shortened by the same amount each time. In some implementations, the amount to shorten the dwell time may be associated with the current dwell time. For example, a ratio between the dwell time and the amount to shorten the dwell time may be used to select, identify, ascertain, or otherwise determine the amount to shorten the dwell time. In this manner, a longer dwell time may be shortened by a larger amount than a shorter dwell time. In addition, the n number of time slots to be used in measuring the congestion may remain fixed or may be adjustable (such as being associated or correlated with the length of the dwell time). In some implementations, the dwell time may be bounded by a minimum dwell time. As such, the wireless communication device may be prevented from reducing the dwell time to less than the minimum dwell time. The minimum dwell time may be any suitable length of time defined at the wireless communication device. In some implementations, one or more of the amount to shorten the dwell time, the n number of time slots to measure the congestion, or the minimum dwell time may be negotiated between the wireless communication device and the NAN peer device.

In some implementations, adjusting the dwell time may include lengthening the dwell time in accordance with the congestion metric being greater than an upper congestion threshold (1312). The congestion metric being greater than an upper congestion threshold may indicate that the congestion is greater than desired for the current dwell time. As such, the current dwell time may be too short, thus causing issues with obtaining access to the wireless medium to transmit an indication or to receive an indication (or other packets) from a NAN peer device. If the dwell time is too short, the wireless communication device may not remain in the active mode for long enough to receive any packets to be transmitted by the NAN peer device to the wireless communication device.

Lengthening the dwell time may be performed in any suitable manner. For example, the dwell time may be lengthened by an amount of time defined at the wireless communication device. The lengthened dwell time may be used the next time a power save indication is transmitted or received (such as during a new CRB). If increased congestion exists on the wireless channel for an extended amount of time, the wireless communication device may recursively measure the congestion during an ever lengthening dwell time and lengthen the dwell time (which may be depicted as lengthening the dwell time in a stepwise manner over time).

The steps in lengthening the dwell time may be fixed or variable. In some implementations, the dwell time may be lengthened by the same amount each time. In some implementations, the amount to lengthen the dwell time may vary in accordance with the current dwell time (such as using a ratio between the dwell time and the amount to lengthen the dwell time). In addition, the n number of time slots to be used in measuring the congestion may remain fixed or may be adjustable (such as being in accordance or correlated with the length of the dwell time). In some implementations, the dwell time may be bounded by a maximum dwell time. As such, the wireless communication device may be prevented from lengthening the dwell time to more than the maximum dwell time. The maximum dwell time may be any suitable length of time defined at the wireless communication device. In some implementations, one or more of the amount to lengthen the dwell time, the n number of time slots to measure the congestion, or the maximum dwell time may be negotiated between the wireless communication device and the NAN peer device.

In some implementations, the upper congestion threshold or the lower congestion threshold may be negotiated between the wireless communication device and the NAN peer device. For example, the congestion metric range between the lower congestion threshold and the upper congestion threshold may be adjusted in accordance with an adjustment to the dwell time. For example, the range may be raised in response to lengthening the dwell time, or the range may be lowered in response to shortening the dwell time. While one range is described, any number of congestion ranges may be used. For example, a plurality of upper congestion thresholds and a plurality of lower congestion thresholds may be used. The amount to adjust the dwell time may be associated or correlated with the number of upper congestion thresholds less than the congestion metric or the number of lower congestion threshold greater than the congestion metric. In this manner, the dwell time may more quickly reach a desired length as compared to using a fixed amount to adjust the dwell time.

In some implementations, the wireless communication device indicates the adjustment to the dwell time to the NAN peer device (1314). For example, the wireless communication device may advertise the adjusted dwell time, and the NAN peer device may adjust a dwell time of the NAN peer device in response. In some implementations, the wireless communication device uses a NAN announcement frame (NAF) to advertise the updated dwell time to the NAN peer device. In another example, the wireless communication device may negotiate a new dwell time with the NAN peer device. In this manner, adjusting the dwell time (1308) and indicating the adjustment to the NAN peer device (1314) may be performed during negotiation of the new dwell time (which may be associated with a congestion measured in step 1302). The dwell time may be indicated as a dwell timer counter value, an absolute value in terms of TUs or time slots, or in any other suitable manner.

In some implementations, if a new dwell time is to be negotiated after the wireless communication device adjusts the dwell time, each NAN device may advertise an associated dwell time (with the wireless communication device's dwell time differing from the NAN peer device's dwell time). For example, the NAN devices may advertise a current dwell time counter value of the NAN devices. Negotiating a new dwell time may include selecting the shortest dwell time from the dwell times being advertised (if the dwell time is being shortened) or the longest dwell time from the dwell times being advertised (if the dwell time is being lengthened). For example, the NAN device may negotiate to use the smallest dwell time counter value or the largest dwell time counter value.

Some examples of adjusting the dwell time in accordance with a congestion are described herein for clarity. However, the dwell time may be adjusted in any suitable manner and using any suitable means. As such, the present disclosure is not limited to a specific example for adjusting the dwell time.

The examples described with reference to FIGS. 6-12 are from the perspective of the NAN device indicating an intention to enter a power save mode. The NAN peer device receiving the indication also may perform one or more operations to facilitate a power save mode in a NAN network.

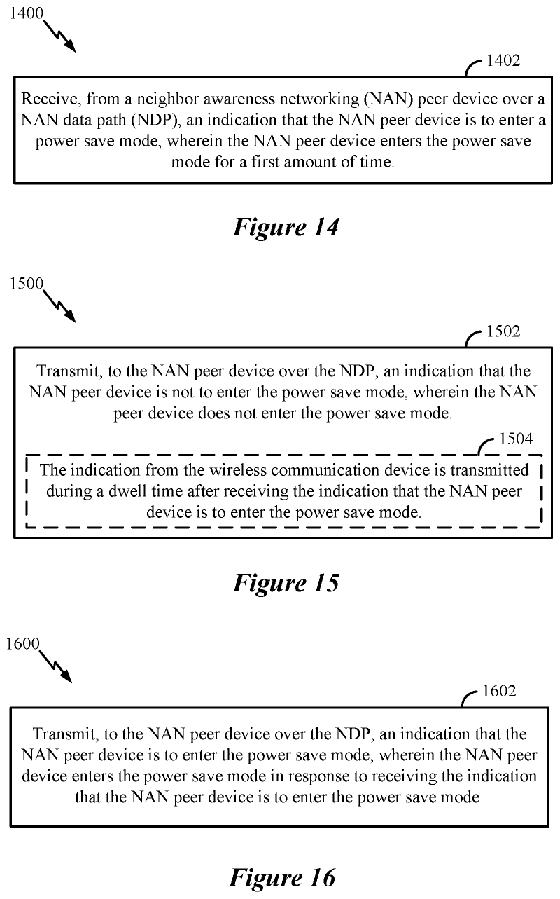

FIG. 14 shows a flowchart illustrating an example process 1400 for power save in a NAN network. The process 1400 is to be performed by the device receiving an indication from a NAN peer device that the NAN peer device is to enter a power save mode. The process 1400 may be performed by a wireless communication device such as the wireless communication device 400 described herein with reference to FIG. 4. In some implementations, the process 1400 may be performed by a wireless communication device operating as or within a STA, such as one of the STAs 304 described herein with reference to FIG. 3. While the process 1400 may be performed by any suitable device, the process 1400 is described as being performed by the wireless communication device 400 for clarity.

At 1402, the wireless communication device receives, from a NAN peer device over an NDP, an indication that the NAN peer device is to enter a power save mode (with the NAN peer device to enter the power save mode for a first amount of time). Step 1402 may be complementary to step 602 in FIG. 6. For example, the NAN peer device to receive the indication transmitted in step 602 may be the wireless communication device in step 1402. As such, the indication in step 1402 may be similar to the indication in step 602 to indicate that a NAN device is to enter a power save mode. The first amount of time and the power save mode also may be the same as described with reference to FIG. 6.

In some implementations, the indication includes a MAC packet with a PM bit set to 1. As noted herein, use of the PM bit set to 1 may be associated with a unilateral trigger condition for a NAN device to enter the power save mode. As such, the NAN peer device transmitting the MAC packet with the PM bit set to 1 to the wireless communication device may enter the power save mode without waiting for a response from the wireless communication device.

In some implementations, the indication includes a MAC packet with a MD bit set to 0. As noted herein, use of the MD bit set to 0 may be associated with a mutually agreed trigger condition for a NAN device to enter the power save mode. As such, the NAN peer device transmitting the MAC packet with the MD bit set to 0 to the wireless communication device may wait for a response from the wireless communication device before entering the power save mode (such as remaining idle for a dwell time before entering the power save mode).

The wireless communication device may require the NAN peer device to remain in an active mode (and not enter a power save mode). For example, the wireless communication device may have data queued for transmission to the NAN peer device. As such, the wireless communication device may indicate to the NAN peer device that the NAN peer device is not to enter the power save mode.

FIG. 15 shows a flowchart illustrating an example process 1500 for preventing a NAN peer device from entering a power save mode. The process 1500 is to be performed by the device receiving an indication from a NAN peer device that the NAN peer device is to enter a power save mode. The process 1500 may be performed by a wireless communication device such as the wireless communication device 400 described herein with reference to FIG. 4. In some implementations, the process 1500 may be performed by a wireless communication device operating as or within a STA, such as one of the STAs 304 described herein with reference to FIG. 3. The process 1500 may be performed in conjunction with process 1400 in FIG. 14.

At 1502, the wireless communication device transmits, to the NAN peer device over the NDP, an indication that the NAN peer device is not to enter the power save mode (with the NAN peer device not entering the power save mode). In some implementations, the wireless communication device may transmit a MAC packet with the MD bit set to 1 to indicate that the NAN peer device is to remain in the active mode. In some implementations, the MAC packet includes a QoS null data packet. In some implementations, the MAC packet includes a MAC data packet (which may include data to be transmitted to the NAN peer device).

In some implementations, the indication from the wireless communication device may be transmitted during a dwell time after receiving the indication that the NAN peer device is to enter the power save mode (1504). As described herein, a dwell time may be negotiated or otherwise adopted at each NAN device. For example, the wireless communication device and the NAN peer device may negotiate the dwell time during setup of the NDP. The wireless communication device may configure a dwell time counter of the wireless communication device to time the dwell time (such as described herein). In response to receiving the indication that the NAN peer device is to enter the power save mode, the wireless communication device may initiate a dwell time counter of the wireless communication device.

Assuming that transmitting the indication by the NAN peer device and receiving the indication by the wireless communication device is instantaneous such that the dwell time counter at the NAN peer device is initiated at the same time that the dwell time counter at the wireless communication device is initiated, the dwell time is synchronized at the wireless communication device and the NAN peer device. However, there may be some delay in the wireless communication device initiating a dwell time counter as compared to the NAN peer device initiating a dwell time counter as a result of latency in transmitting, receiving, and processing the indication. The latency may be known (such as being associated with or dependent on known delays in transmission, reception, and processing) or may be calculated (such as the indication including a time stamp or other time indication that can be used to calculate the latency in accordance with or using a synchronized clock between the NAN devices). In some implementations, the wireless communication device may compensate for the latency to synchronize the dwell times between the NAN devices. For example, the wireless communication device may adjust the dwell time counter value (such as decrease the value) to compensate for the latency.

With the wireless communication device able to time the dwell time during which the NAN peer device is to remain idle (such as using the adjusted dwell time counter), the wireless communication device may be configured to transmit the indication to the NAN peer device during the dwell time such that the NAN peer device can receive the indication from the wireless communication device during the dwell time. If the indication is to prevent the NAN peer device from entering a power save mode, the indication being transmitted during the dwell time may allow the NAN peer device to receive the indication before the NAN peer device would enter into the power save mode at the end of the dwell time (such as in accordance with the NAN peer device not receiving data and not receiving an indication during the dwell time). With the NAN peer device preventing entering into the power save mode, the wireless communication device may continue to transmit MAC data packets or other NAN packets to the NAN peer device that remains in the active mode.

In some instances, the wireless communication device may not require the NAN peer device to stay in the active mode. For example, the wireless communication device may have no data queued for transmission to the NAN peer device or otherwise may not need to transmit to the NAN peer device. In some implementations, the wireless communication device may indicate that the NAN peer device is to enter the power save mode.

FIG. 16 shows a flowchart illustrating an example process 1600 for indicating a NAN peer device is to enter a power save mode. The process 1600 is to be performed by the device receiving an indication from a NAN peer device that the NAN peer device is to enter a power save mode. The process 1600 may be performed by a wireless communication device such as the wireless communication device 400 described herein with reference to FIG. 4. In some implementations, the process 1600 may be performed by a wireless communication device operating as or within a STA, such as one of the STAs 304 described herein with reference to FIG. 3. The process 1600 may be performed in conjunction with process 1400 in FIG. 14.

At 1602, the wireless communication device transmits, to the NAN peer device over the NDP, an indication that the NAN peer device is to enter the power save mode. The NAN peer device may enter the power save mode in response to receiving the indication that the NAN peer device is to enter the power save mode. In some implementations, the indication includes a MAC packet with the MD bit set to 0. In some implementations, the MAC packet includes a QoS null data packet. In some other implementations, the MAC packet includes a MAC data packet. For example, if data is being transferred to the NAN peer device in a MAC data packet and no further data is to be transferred to the NAN peer device, the MAC data packet may include an MD bit set to 0 to indicate that the NAN peer device is to enter the power save mode.

If the indication to enter the power save mode is the first indication transmitted by the wireless communication device after receiving the indication from the NAN peer device, the wireless communication device may transmit the indication during the dwell time after the indication from the NAN peer device (such as described herein with reference to step 1504). In this manner, the NAN peer device may enter the power save mode before the end of the dwell time. In some implementations, the indication from the wireless communication device may be after one or more other indications from the wireless communication device preventing the NAN peer device from entering the power save mode. For example, if the wireless communication device has data queued for transmission to the NAN peer device, the wireless communication device may transmit one or more MAC data packets including the queued data. Each MAC data packet may have the MD bit set to 1 to indicate that the NAN peer device is to remain in the active mode. The last MAC data packet may have the MD bit set to 0, or a separate QoS null data packet with the MD bit set to 0 may be sent after the last MAC data packet. In this manner, the wireless communication device may indicate after the dwell time that the NAN peer device is to enter the power save mode (such as illustrated in FIG. 12 from the perspective of the NAN peer device).

In some implementations, the wireless communication device may enter a power save mode after transmitting the indication that the NAN peer device is to enter the power save mode. For example, since the NAN peer device is to be in a power save mode for a first amount of time, no packets are to be transmitted to or received from the NAN peer device during the first amount of time. As such, the wireless communication device also may enter a power save mode for the first amount of time. The wireless communication device may enter the power save mode after transmitting the indication that the NAN peer device is to enter the power save mode.

As noted herein, the first amount of time may be defined at both NAN devices (such as being negotiated during setup of the NDP), the NAN peer device enters the power save mode in response to receiving the indication from the wireless communication device to enter the power save mode, and the wireless communication device enters the power save mode after transmitting the indication to the NAN peer device. Assuming that transmitting the indication, receiving and processing the indication, and entering the power save mode is instantaneous at both devices, the wireless communication device and the NAN peer device may be in the power save mode for the same period of time. However, a latency exists in transmission, reception, processing, and entering into a power save mode.

In some implementations, the wireless communication device and the NAN peer device compensate for the latency. For example, if the NAN peer device enters the power save mode a known amount of time after the wireless communication device transmits the indication (such as in accordance with a known or calculable latency), the wireless communication device may delay entering the power save mode for the latency amount so that the NAN peer device and the wireless communication device are in the power save mode at the same time. In another example, the wireless communication device may enter the power save mode immediately after transmitting the indication, and the NAN peer device may shorten the first amount of time to be in the power save mode in accordance with the latency so that the power save modes end at the same time (and the wireless communication device and the NAN peer device return to the active mode at the same time). While some example implementations of synchronizing the power save modes and synchronizing the dwell times are provided, such synchronizations may be performed in any suitable manner.

As described herein, the NAN devices of a NAN network may include a mechanism for power save. Through the use of the power save mechanism, the NAN devices may conserve processing and power resources without impacting the performance of the NAN network. While the examples are described with reference to a NAN device pair for a one-hop NDL, the aspects described herein also may be applied to NDLs including more than two NAN devices or other configurations of a NAN network. For example, in setting up an NDP for an NDL including more than two NAN devices, a dwell time, a power save mode time, one or more congestion metrics, and so on may be set (such as negotiated) for a plurality of NAN devices (such as for all NAN devices of an NDC). As such, the aspects described herein may be applied to any NAN network configuration to provide a NAN device of the NAN network a power save mechanism.

Implementation examples are described in the following numbered clauses:
1. A wireless communication device for neighbor awareness networking (NAN) communications, including:
an interface configured to:
   transmit, to a NAN peer device over a NAN data path (NDP), an indication that the wireless communication device is to enter a power save mode; and a processing system configured to:
   cause the wireless communication device to enter into the power save mode for a first amount of time.
2. The wireless communication device of clause 1, where:
the indication includes a media access control (MAC) packet with a power management (PM) bit set to 1.
3. The wireless communication device of clause 1, where:
the indication includes a media access control (MAC) packet with a more data (MD) bit set to 0.
4. The wireless communication device of clause 1, where the processing system is configured to:
cause the wireless communication device to remain in an active mode during a dwell time after transmitting the indication.
5. The wireless communication device of clause 4, where the processing system is configured to:
cause the wireless communication device to remain idle during the dwell time, where:
   the wireless communication device does not receive traffic intended for the wireless communication device; and
   the wireless communication device enters the power save mode after the dwell time.
6. The wireless communication device of clause 4, where:
the interface is configured to:
   receive one or more of:
      data intended for the wireless communication device during the dwell time; or
      an indication, from the NAN peer device over the NDP, that the wireless communication device is not to enter the power save mode; and the processing system is configured to:
   prevent the wireless communication device from entering the power save mode.
7. The wireless communication device of clause 6, where:
   the indication from the NAN peer device includes a media access control (MAC) packet with a more data (MD) bit set to 1.
8. The wireless communication device of clause 7, where:
   the MAC packet from the NAN peer device includes a quality of service (QoS) null data packet.
9. The wireless communication device of clause 4, where:
   the interface is configured to:
      receive, from the NAN peer device over the NDP, an indication that the wireless communication device is to enter the power save mode; and the processing system is configured to:
      cause the wireless communication device to enter the power save mode in response to receiving the indication that the wireless communication device is to enter the power save mode.
10. The wireless communication device of clause 9, where:
the indication that the wireless communication device is to enter the power save mode includes a media access control (MAC) packet with a more data (MD) bit set to 0.
11. The wireless communication device of clause 10, where:
the MAC packet from the NAN peer device includes a quality of service (QoS) null data packet.
12. The wireless communication device of clause 9, where the processing system is configured to:
end the dwell time in response to receiving the indication that the wireless communication device is to enter the power save mode.
13. The wireless communication device of clause 4, where the processing system is configured to:
negotiate the dwell time with the NAN peer device during setup of the NDP.
14. The wireless communication device of clause 4, where the processing system is configured to:
measure a congestion on a portion of a wireless medium including the NDP; and
adjust the dwell time based on the congestion.
15. The wireless communication device of clause 14, where the interface is configured to:
indicate the adjustment to the dwell time to the NAN peer device.
16. The wireless communication device of clause 14, where:
measuring the congestion includes generating a congestion metric; and
adjusting the dwell time includes one or more of:
   shortening the dwell time based on the congestion metric being less than a lower congestion threshold; or
   lengthening the dwell time based on the congestion metric being greater than an upper congestion threshold.
17. The wireless communication device of clause 14, where:
measuring the congestion includes performing a clear channel assessment (CCA) over a last n number of time slots.
18. The wireless communication device of clause 14, where:
measuring the congestion includes identifying a number of frames not intended for the wireless communication device that are exchanged over a last n number of time slots.
19. The wireless communication device of clause 1, where:
the first amount of time is less than or equal to a maximum power save mode time associated with the NDP.
20. The wireless communication device of clause 19, where:
the interface is configured to:
   transmit, to the NAN peer device, an indication of a first power save mode time associated with the wireless communication device; and
   receive an indication of a second power save mode time associated with the NAN peer device; and
the processing system is configured to:
   negotiate, with the NAN peer device, the maximum power save mode time as a minimum from the first power save mode time and the second power save mode time.
21. The wireless communication device of clause 20, where:
the first power save mode time is based on time slots during which the wireless communication device is to be in an active mode.
22. The wireless communication device of clause 21, where:
the time slots are based on one or more of
   a latency requirement for data transmissions between the wireless communication device and the NAN peer device; or
   a pattern of previous traffic intended for the wireless communication device.
23. The wireless communication device of clause 1, where:
   the NDP includes one or more common resource blocks (CRBs) during which the wireless communication device and the NAN peer device are to be in an active mode for exchanging NAN frames between each other; and
   the one or more CRBs are associated with a negotiated schedule of time slots during which both the wireless communication device and the NAN peer device are available.
24. The wireless communication device of claim 23, wherein the one or more CRBs include one or more blocks of time, and wherein a transmission opportunity period between the wireless communication device and the NAN peer device includes the one or more blocks of time.
25. The wireless communication device of claim 24, wherein the processing system is configured to cause the wireless communication device to perform an operation between the one or more blocks of time, wherein the operation includes entering the power save mode between the one or more blocks of time.
26. The wireless communication device of claim 24, wherein:
the one or more blocks of time are contiguous; or
the one or more blocks of time are non-contiguous, wherein the wireless communication device enters the power save mode during non-transmission blocks of time, the non-transmission blocks of time being between the one or more blocks of time during which both the wireless communication device and the NAN peer device are available, and wherein the wireless communication device and the NAN peer device negotiate at what time the wireless communication device is to enter the power save mode during the non-transmission blocks of time in accordance with the one or more blocks of time being non-contiguous.
27. The wireless communication device of claim 24, wherein each block of time of the blocks of time is negotiated to be in a range of 1 to 16 time units (TUs).
28. A method performed by an apparatus of a wireless communication device, including:
transmitting, to a neighbor awareness networking (NAN) peer device over a NAN data path (NDP), an indication that the wireless communication device is to enter a power save mode; and
entering the power save mode for a first amount of time.
29. The method of clause 24, where:
the indication includes a media access control (MAC) packet with a power management (PM) bit set to 1.
30. The method of clause 24, where:
the indication includes a media access control (MAC) packet with a more data (MD) bit set to 0.
31. The method of clause 24, further including:
remaining in an active mode during a dwell time after transmitting the indication.
32. The method of clause 27, further including:
remaining idle during the dwell time, where:
   the wireless communication device does not receive traffic intended for the wireless communication device; and
   the wireless communication device enters the power save mode after the dwell time.
33. The method of clause 27, further including:
receiving one or more of:
   data intended for the wireless communication device during the dwell time; or
   an indication, from the NAN peer device over the NDP, that the wireless communication device is not to enter the power save mode; and preventing entering the power save mode.
34. The method of clause 29, where:
the indication from the NAN peer device includes a media access control (MAC) packet with a more data (MD) bit set to 1.
35. The method of clause 30, where:
the MAC packet from the NAN peer device includes a quality of service (QoS) null data packet.
36. The method of clause 27, further including:
receiving, from the NAN peer device over the NDP, an indication that the wireless communication device is to enter the power save mode; and
entering the power save mode in response to receiving the indication that the wireless communication device is to enter the power save mode.
37. The method of clause 32, where:
the indication that the wireless communication device is to enter the power save mode includes a media access control (MAC) packet with a more data (MD) bit set to 0.
38. The method of clause 33, where:
the MAC packet from the NAN peer device includes a quality of service (QoS) null data packet.
39. The method of clause 32, further including:
ending the dwell time in response to receiving the indication that the wireless communication device is to enter the power save mode.
40. The method of clause 27, further including:
negotiating the dwell time with the NAN peer device during setup of the NDP.
41. The method of clause 27, further including:
measuring a congestion on a portion of a wireless medium including the NDP; and
adjusting the dwell time based on the congestion.
42. The method of clause 37, further including:
indicating the adjustment to the dwell time to the NAN peer device.
43. The method of clause 37, where:
measuring the congestion includes generating a congestion metric; and
adjusting the dwell time includes one or more of
   shortening the dwell time based on the congestion metric being less than a lower congestion threshold; or
   lengthening the dwell time based on the congestion metric being greater than an upper congestion threshold.
44. The method of clause 37, where:
measuring the congestion includes performing a clear channel assessment (CCA) over a last n number of time slots.
45. The method of clause 37, where:
measuring the congestion includes identifying a number of frames not intended for the wireless communication device that are exchanged over a last n number of time slots.
46. The method of clause 24, where:
the first amount of time is less than or equal to a maximum power save mode time associated with the NDP.
47. The method of clause 42, further including:
transmitting, to the NAN peer device, an indication of a first power save mode time associated with the wireless communication device;
receiving an indication of a second power save mode time associated with the NAN peer device; and
negotiating, with the NAN peer device, the maximum power save mode time as a minimum from the first power save mode time and the second power save mode time.
48. The method of clause 43, where:
the first power save mode time is based on time slots during which the wireless communication device is to be in an active mode.
49. The method of clause 44, where:
the time slots are based on one or more of:
   a latency requirement for data transmissions between the wireless communication device and the NAN peer device; or
   a pattern of previous traffic intended for the wireless communication device.
50. The method of clause 24, where:
the NDP includes one or more common resource blocks (CRBs) during which the wireless communication device and the NAN peer device are to be in an active mode for exchanging NAN frames between each other; and
the CRB is based on a negotiated schedule of contiguous time slots during which both the wireless communication device and the NAN peer device are available.
51. A wireless communication device for neighbor awareness networking (NAN) communications, including:
a processing system; and
an interface configured to:
   receive, from a NAN peer device over a NAN data path (NDP), an indication that the NAN peer device is to enter a power save mode, where the NAN peer device enters the power save mode for a first amount of time.
52. The wireless communication device of clause 47, where:
the indication includes a media access control (MAC) packet with a power management (PM) bit set to 1.
53. The wireless communication device of clause 47, where:
the indication includes a media access control (MAC) packet with a more data (MD) bit set to 0.
54. The wireless communication device of clause 47, where the interface is configured to:
transmit, to the NAN peer device over the NDP, an indication that the NAN peer device is not to enter the power save mode, where the NAN peer device does not enter the power save mode.
55. The wireless communication device of clause 50, where the interface is configured to:
transmit the indication during a dwell time after receiving the indication that the NAN peer device is to enter the power save mode.
56. The wireless communication device of clause 50, where:
the indication to the NAN peer device includes a media access control (MAC) packet with a more data (MD) bit set to 1.
57. The wireless communication device of clause 52, where:
the MAC packet to the NAN peer device includes a quality of service (QoS) null data packet.
58. The wireless communication device of clause 47, where the interface is configured to:
transmit, to the NAN peer device over the NDP, an indication that the NAN peer device is to enter the power save mode, where the NAN peer device enters the power save mode in response to receiving the indication that the NAN peer device is to enter the power save mode.
59. The wireless communication device of clause 54, where:
the indication that the NAN peer device is to enter the power save mode includes a media access control (MAC) packet with a more data (MD) bit set to 0.
60. The wireless communication device of clause 55, where:
the MAC packet to the NAN peer device includes a quality of service (QoS) null data packet.
61. A method performed by an apparatus of a wireless communication device, including:
receiving, from a neighbor awareness networking (NAN) peer device over a NAN data path (NDP), an indication that the NAN peer device is to enter a power save mode, where the NAN peer device enters the power save mode for a first amount of time.
62. The method of clause 57, where:
the indication includes a media access control (MAC) packet with a power management (PM) bit set to 1.
63. The method of clause 57, where:
the indication includes a media access control (MAC) packet with a more data (MD) bit set to 0.
64. The method of clause 57, further including:
transmitting, to the NAN peer device over the NDP, an indication that the NAN peer device is not to enter the power save mode, where the NAN peer device does not enter the power save mode.
65. The method of clause 60, where the indication from the wireless communication device is transmitted during a dwell time after receiving the indication that the NAN peer device is to enter the power save mode.
66. The method of clause 60, where:
the indication to the NAN peer device includes a media access control (MAC) packet with a more data (MD) bit set to 1.
67. The method of clause 62, where:
the MAC packet to the NAN peer device includes a quality of service (QoS) null data packet.
68. The method of clause 57, further including:
transmitting, to the NAN peer device over the NDP, an indication that the NAN peer device is to enter the power save mode, where the NAN peer device enters the power save mode in response to receiving the indication that the NAN peer device is to enter the power save mode.
69. The method of clause 64, where:
the indication that the NAN peer device is to enter the power save mode includes a media access control (MAC) packet with a more data (MD) bit set to 0.
70. The method of clause 65, where:
the MAC packet to the NAN peer device includes a quality of service (QoS) null data packet.
71. An apparatus of a wireless communication device, including:
means for transmitting, to a neighbor awareness networking (NAN) peer device over a NAN data path (NDP), an indication that the wireless communication device is to enter a power save mode; and
means for entering the power save mode for a first amount of time.
72. The apparatus of clause 67, where:
the indication includes a media access control (MAC) packet with a power management (PM) bit set to 1.
73. The apparatus of clause 67, where:
the indication includes a media access control (MAC) packet with a more data (MD) bit set to 0.
74. The apparatus of clause 67, further including:
means for remaining in an active mode during a dwell time after transmitting the indication.
75. The apparatus of clause 70, further including:
means for remaining idle during the dwell time, where:
   the wireless communication device does not receive traffic intended for the wireless communication device; and
   the wireless communication device enters the power save mode after the dwell time.
76. The apparatus of clause 70, further including:
means for receiving one or more of
   data intended for the wireless communication device during the dwell time; or
   an indication, from the NAN peer device over the NDP, that the wireless communication device is not to enter the power save mode; and preventing entering the power save mode.
77. The apparatus of clause 72, where:
the indication from the NAN peer device includes a media access control (MAC) packet with a more data (MD) bit set to 1.
78. The apparatus of clause 73, where:
the MAC packet from the NAN peer device includes a quality of service (QoS) null data packet.
79. The apparatus of clause 70, further including:
means for receiving, from the NAN peer device over the NDP, an indication that the wireless communication device is to enter the power save mode; and
means for entering the power save mode in response to receiving the indication that the wireless communication device is to enter the power save mode.
80. The apparatus of clause 75, where:
the indication that the wireless communication device is to enter the power save mode includes a media access control (MAC) packet with a more data (MD) bit set to 0.
81. The apparatus of clause 76, where:
the MAC packet from the NAN peer device includes a quality of service (QoS) null data packet.
82. The apparatus of clause 75, further including:
means for ending the dwell time in response to receiving the indication that the wireless communication device is to enter the power save mode.
83. The apparatus of clause 70, further including:
means for negotiating the dwell time with the NAN peer device during setup of the NDP.
84. The apparatus of clause 70, further including:
means for measuring a congestion on a portion of a wireless medium including the NDP; and
means for adjusting the dwell time based on the congestion.
85. The apparatus of clause 80, further including:
means for indicating the adjustment to the dwell time to the NAN peer device.
86. The apparatus of clause 80, where:
measuring the congestion includes generating a congestion metric; and
adjusting the dwell time includes one or more of
   shortening the dwell time based on the congestion metric being less than a lower congestion threshold; or
   lengthening the dwell time based on the congestion metric being greater than an upper congestion threshold.
87. The apparatus of clause 80, where:
measuring the congestion includes performing a clear channel assessment (CCA) over a last n number of time slots.
88. The apparatus of clause 80, where:
measuring the congestion includes identifying a number of frames not intended for the wireless communication device that are exchanged over a last n number of time slots.
89. The apparatus of clause 67, where:
the first amount of time is less than or equal to a maximum power save mode time associated with the NDP.
90. The apparatus of clause 85, further including:
means for transmitting, to the NAN peer device, an indication of a first power save mode time associated with the wireless communication device;
means for receiving an indication of a second power save mode time associated with the NAN peer device; and
means for negotiating, with the NAN peer device, the maximum power save mode time as a minimum from the first power save mode time and the second power save mode time.
91. The apparatus of clause 86, where:
the first power save mode time is based on time slots during which the wireless communication device is to be in an active mode.
92. The apparatus of clause 87, where:
the time slots are based on one or more of:
   a latency requirement for data transmissions between the wireless communication device and the NAN peer device; or
   a pattern of previous traffic intended for the wireless communication device.
93. The apparatus of clause 67, where:
the NDP includes one or more common resource blocks (CRBs) during which the wireless communication device and the NAN peer device are to be in an active mode for exchanging NAN frames between each other; and
the CRB is based on a negotiated schedule of contiguous time slots during which both the wireless communication device and the NAN peer device are available.
94. An apparatus of a wireless communication device, including:
means for receiving, from a neighbor awareness networking (NAN) peer device over a NAN data path (NDP), an indication that the NAN peer device is to enter a power save mode, where the NAN peer device enters the power save mode for a first amount of time.
95. The apparatus of clause 90, where:
the indication includes a media access control (MAC) packet with a power management (PM) bit set to 1.
96. The apparatus of clause 90, where:
the indication includes a media access control (MAC) packet with a more data (MD) bit set to 0.
97. The apparatus of clause 90, further including:
means for transmitting, to the NAN peer device over the NDP, an indication that the NAN peer device is not to enter the power save mode, where the NAN peer device does not enter the power save mode.
98. The apparatus of clause 93, where the indication from the wireless communication device is transmitted during a dwell time after receiving the indication that the NAN peer device is to enter the power save mode.
99. The apparatus of clause 93, where:
the indication to the NAN peer device includes a media access control (MAC) packet with a more data (MD) bit set to 1.
100. The apparatus of clause 95, where:
the MAC packet to the NAN peer device includes a quality of service (QoS) null data packet.
101. The apparatus of clause 90, further including:
means for transmitting, to the NAN peer device over the NDP, an indication that the NAN peer device is to enter the power save mode, where the NAN peer device enters the power save mode in response to receiving the indication that the NAN peer device is to enter the power save mode.
102. The apparatus of clause 97, where:
the indication that the NAN peer device is to enter the power save mode includes a media access control (MAC) packet with a more data (MD) bit set to 0.
103. The apparatus of clause 98, where:
the MAC packet to the NAN peer device includes a quality of service (QoS) null data packet.

As used herein, “or” is intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of a, b, or c” is intended to cover the examples of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the potential implementations are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially embodied as such, one or more features from a embodied combination can in some implementations be excised from the combination, and the embodied combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

What is claimed is:

1. A wireless communication device for neighbor awareness networking (NAN) communications, comprising:
an interface configured to:
output, to a NAN peer device over a NAN data path (NDP), an indication that the wireless communication device is to enter a power save mode; and
a processing system configured to:
cause the wireless communication device to enter into the power save mode for a first amount of time.

2. The wireless communication device of claim 1, wherein:
the indication includes a media access control (MAC) packet with a power management (PM) bit set to 1 or a more data (MD) bit set to 0.

3. The wireless communication device of claim 1, wherein the processing system is configured to:
cause the wireless communication device to remain in an active mode during a dwell time after outputting the indication.

4. The wireless communication device of claim 3, wherein the processing system is configured to:
cause the wireless communication device to remain idle during the dwell time, wherein:
the wireless communication device does not obtain traffic intended for the wireless communication device; and
the wireless communication device enters the power save mode after the dwell time.

5. The wireless communication device of claim 3, wherein:
the interface is configured to:
obtain one or more of:
data intended for the wireless communication device during the dwell time; or
an indication, from the NAN peer device over the NDP, that the wireless communication device is not to enter the power save mode, wherein the indication from the NAN peer device includes a media access control (MAC) packet with a more data (MD) bit set to 1; and
the processing system is configured to:
prevent the wireless communication device from entering the power save mode.

6. The wireless communication device of claim 3, wherein:
the interface is configured to:
obtain, from the NAN peer device over the NDP, an indication that the wireless communication device is to enter the power save mode, wherein the indication that the wireless communication device is to enter the power save mode includes a media access control (MAC) packet with a more data (MD) bit set to 0 and the MAC packet from the NAN peer device includes a quality of service (QoS) null data packet; and
the processing system is configured to:
cause the wireless communication device to enter the power save mode in response to obtaining the indication that the wireless communication device is to enter the power save mode.

7. The wireless communication device of claim 6, wherein the processing system is configured to:
end the dwell time in response to obtaining the indication that the wireless communication device is to enter the power save mode.

8. The wireless communication device of claim 3, wherein the processing system is configured to:
negotiate the dwell time with the NAN peer device during setup of the NDP.

9. The wireless communication device of claim 3, wherein:
the processing system is configured to:
measure a congestion on a portion of a wireless medium including the NDP; and
adjust the dwell time in accordance with the congestion; and
the interface is configured to:
indicate the adjustment to the dwell time to the NAN peer device.

10. The wireless communication device of claim 9, wherein:
measuring the congestion includes generating a congestion metric; and
adjusting the dwell time includes one or more of:
shortening the dwell time in accordance with the congestion metric being less than a lower congestion threshold; or
lengthening the dwell time in accordance with the congestion metric being greater than an upper congestion threshold.

11. The wireless communication device of claim 1, wherein:
the first amount of time is less than or equal to a maximum power save mode time associated with the NDP.

12. The wireless communication device of claim 11, wherein:
the interface is configured to:
output, to the NAN peer device, an indication of a first power save mode time associated with the wireless communication device, wherein the first power save mode time is associated with time slots during which the wireless communication device is to be in an active mode, and wherein the time slots are associated with one or more of a latency requirement for data transmissions between the wireless communication device and the NAN peer device or a pattern of previous traffic intended for the wireless communication device; and
obtain an indication of a second power save mode time associated with the NAN peer device; and
the processing system is configured to:
negotiate, with the NAN peer device, the maximum power save mode time as a minimum from the first power save mode time and the second power save mode time.

13. The wireless communication device of claim 1, wherein:
the NDP includes one or more common resource blocks (CRBs) during which the wireless communication device and the NAN peer device are to be in an active mode for exchanging NAN frames between each other; and
the one or more CRBs are associated with a negotiated schedule of time slots during which both the wireless communication device and the NAN peer device are available.

14. The wireless communication device of claim 13, wherein the one or more CRBs include one or more blocks of time, and wherein a transmission opportunity period between the wireless communication device and the NAN peer device includes the one or more blocks of time.

15. The wireless communication device of claim 14, wherein the processing system is configured to cause the wireless communication device to perform an operation between the one or more blocks of time, wherein the operation includes entering the power save mode between the one or more blocks of time.

16. The wireless communication device of claim 14, wherein:
the one or more blocks of time are contiguous; or
the one or more blocks of time are non-contiguous, wherein the wireless communication device enters the power save mode during non-transmission blocks of time, the non-transmission blocks of time being between the one or more blocks of time during which both the wireless communication device and the NAN peer device are available, and wherein the wireless communication device and the NAN peer device negotiate at what time the wireless communication device is to enter the power save mode during the non-transmission blocks of time in accordance with the one or more blocks of time being non-contiguous.

17. The wireless communication device of claim 14, wherein each block of time of the blocks of time is negotiated to be in a range of 1 to 16 time units (TUs).

18. A method performed by an apparatus of a wireless communication device, comprising:
transmitting, to a neighbor awareness networking (NAN) peer device over a NAN data path (NDP), an indication that the wireless communication device is to enter a power save mode; and
entering the power save mode for a first amount of time.

19. The method of claim 14, wherein:
the indication includes a media access control (MAC) packet with a power management (PM) bit set to 1 or a more data (MD) bit set to 0.

20. The method of claim 14, further comprising:
remaining in an active mode during a dwell time after transmitting the indication.

21. The method of claim 16, further comprising:
receiving one or more of:
data intended for the wireless communication device during the dwell time; or
an indication, from the NAN peer device over the NDP, that the wireless communication device is not to enter the power save mode, wherein the indication from the NAN peer device includes a media access control (MAC) packet with a more data (MD) bit set to 1; and
preventing entering the power save mode.

22. The method of claim 16, further comprising:
receiving, from the NAN peer device over the NDP, an indication that the wireless communication device is to enter the power save mode, wherein the indication that the wireless communication device is to enter the power save mode includes a media access control (MAC) packet with a more data (MD) bit set to 0; and
entering the power save mode in response to receiving the indication that the wireless communication device is to enter the power save mode.

23. A wireless communication device for neighbor awareness networking (NAN) communications, comprising:
a processing system; and
an interface configured to:
obtain, from a NAN peer device over a NAN data path (NDP), an indication that the NAN peer device is to enter a power save mode, wherein the NAN peer device enters the power save mode for a first amount of time.

24. The wireless communication device of claim 19, wherein:
the indication includes a media access control (MAC) packet with a power management (PM) bit set to 1 or a more data (MD) bit set to 0.

25. The wireless communication device of claim 19, wherein the interface is configured to:
output, to the NAN peer device over the NDP, an indication that the NAN peer device is not to enter the power save mode, wherein the NAN peer device does not enter the power save mode.

26. The wireless communication device of claim 21, wherein the interface is configured to:
output the indication during a dwell time after obtaining the indication that the NAN peer device is to enter the power save mode, wherein the indication to the NAN peer device includes a media access control (MAC) packet with a more data (MD) bit set to 1.

27. A method performed by an apparatus of a wireless communication device, comprising:
receiving, from a neighbor awareness networking (NAN) peer device over a NAN data path (NDP), an indication that the NAN peer device is to enter a power save mode, wherein the NAN peer device enters the power save mode for a first amount of time.

28. The method of claim 26, wherein:
the indication includes a media access control (MAC) packet with a power management (PM) bit set to 1 or a more data (MD) bit set to 0.

29. The method of claim 26, further comprising: transmitting, to the NAN peer device over the NDP during a dwell time after receiving the indication that the NAN peer device is to enter the power save mode, an indication that the NAN peer device is not to enter the power save mode, wherein the NAN peer device does not enter the power save mode, wherein the indication to the NAN peer device includes a media access control (MAC) packet with a more data (MD) bit set to 1.

30. The method of claim 26, further comprising:
transmitting, to the NAN peer device over the NDP, an indication that the NAN peer device is to enter the power save mode, where the NAN peer device enters the power save mode in response to receiving the indication that the NAN peer device is to enter the power save mode.
